(19) United States
(12) Patent Application Publication
(10) Pub. No.: US 2016/0071526 A1
(43) Pub. Date: Mar. 10, 2016

(54) ACOUSTIC SOURCE TRACKING AND SELECTION

(71) Applicant: ANALOG DEVICES, INC., Norwood, MA (US)

(72) Inventors: DAVID WINGATE, ASHLAND, MA (US); NOAH DANIEL STEIN, SOMERVILLE, MA (US); BENJAMIN VIGODA, WINCHESTER, MA (US); PATRICK OHIOMOBA, BOSTON, MA (US); BRIAN DONNELLY, SUDBURY, MA (US)

(73) Assignee: ANALOG DEVICES, INC., Norwood, MA (US)

(21) Appl. No.: 14/847,818

(22) Filed: Sep. 8, 2015

Related U.S. Application Data
(60) Provisional application No. 62/048,012, filed on Sep. 9, 2014.
(60) Provisional application No. 62/138,515, filed on Mar. 26, 2015.

(51) Int. Cl. G10L 21/028; G10L 25/84; G10L 19/022; G01S 3/802; G10L 21/0232; G10L 21/0264

(52) U.S. Cl. CPC G10L 21/028; G10L 21/0232; G10L 21/0264; G10L 19/022; G01S 3/802; G10L 25/84

(57) ABSTRACT

The present disclosure relates generally to improving acoustic source tracking and selection and, more particularly, to techniques for acoustic source tracking and selection using motion or position information. Embodiments of the present disclosure include systems designed to select and track acoustic sources. In one embodiment, the system may be realized as an integrated circuit including a microphone array, motion sensing circuitry, position sensing circuitry, analog-to-digital converter (ADC) circuitry configured to convert analog audio signals from the microphone array into digital audio signals for further processing, and a digital signal processor (DSP) or other circuitry for processing the digital audio signals based on motion data and other sensor data. Sensor data may be correlated to the analog or digital audio signals to improve source separation or other audio processing.

### CROSS-REFERENCE TO RELATED APPLICATIONS

This application claims the benefit of and priority from U.S. Provisional Patent Application Ser. No. 62/048,012 filed 9 Sep. 2014 entitled “Acoustic source tracking and selection”, which is incorporated herein by reference in its entirety.

This application also claims the benefit of and priority from U.S. Provisional Patent Application Ser. No. 62/138,515 filed 26 Mar. 2015 entitled “Nonnegative tensor factorization methods for blind source separation”, which is also incorporated herein by reference in its entirety.

### FIELD

The present disclosure relates generally to improving acoustic source tracking and selection and, more particularly, to techniques for acoustic source tracking and selection using motion sensors or other sensors.

### BACKGROUND

The capability of electronic devices to listen to the world around them is increasingly important. For example, automatic speech recognition (ASR) enables users to interact with electronic devices using their voices. However, noisy environments make it challenging for a device to process audio from a particular speaker or other acoustic source. The audio signal received at a microphone will often be a combination of the audio from the acoustic source of interest and noise from any number of other acoustic sources. Selecting the preferred audio signal and tracking its acoustic source present significant engineering challenges, particularly in cases where the orientation and position of the electronic device moves relative to an orientation and position of a preferred acoustic source, as well as in cases where environment changes lead to changes in the sources of noise.

Source separation often presents even greater challenges than speech recognition. Speech recognition is different from source separation in that speech recognition does not need to reconstruct clean separated audio. Speech recognition should be robust to background noise, but this is easier to accomplish than source separation because the recognizer outputs a discrete response in terms of words rather than a waveform, which has the potential to have arbitrary distortion and artifacts. Also the implications for a failure of the two types of system are different. A failure or suboptimal operation of a speech recognition algorithm will likely lead to the user repeating the utterance. A failure or suboptimal operation of a source separation algorithm may result in someone hearing badly distorted audio, which may be less desirable.

### SUMMARY

Embodiments of the present disclosure include systems designed to select and track acoustic sources. In one embodiment, the system may be realized as an integrated circuit including a microphone array, motion sensing circuitry, position sensing circuitry, analog-to-digital converter (ADC) circuitry configured to convert analog audio signals from the microphone array into digital audio signals for further processing, and a digital signal processor (DSP) or other circuitry for processing the digital audio signals based on motion data from the motion sensing circuitry or position data from the position sensing circuitry.

In some embodiments, the system may include beamforming circuitry preconfigured for a geometry of the microphone array.

In some embodiments, the DSP or other circuitry for processing the digital audio signals may include source separation circuitry, which may be based on input from additional sensors of the system.

In some embodiments, the system for processing at least one signal acquired using one or more acoustic sensors is disclosed. The at least one signal has contributions from one or more acoustic sources, typically a plurality of acoustic sources. The system may include a memory configured to store computer executable instructions and a processor communicatively connected to or comprising the memory and configured, when executing the instructions, to obtain sensor data from one or more sensors other than the one or more acoustic sensors and use the sensor data in executing an acoustic source separation algorithm on the at least one acquired signal to separate from the at least one acquired signal one or more contributions from a predetermined acoustic source of the one or more acoustic sources.

Several different manners for carrying out the acoustic source separation algorithms are disclosed.

In some embodiments, the acoustic source separation algorithm includes computing time-dependent spectral characteristics from the at least one acquired signal, the spectral characteristics comprising a plurality of components; computing direction estimates from at least two signals acquired using one or more acoustic sensors, each component of a first subset of the plurality of components having a corresponding one or more of the direction estimates; and performing iterations of a nonnegative tensor factorization (NTF) model for the one or more acoustic sources, the iterations comprising (a) combining values of a plurality of parameters of the NTF model with the computed direction estimates to separate from the acquired signals one or more contributions from the predetermined acoustic source.

In some embodiments, the acoustic source separation algorithm includes computing time-dependent spectral characteristics from the at least one acquired signal, the spectral characteristics comprising a plurality of components; applying a first model to the time-dependent spectral characteristics, the first model configured to compute property estimates of a property, each component of a first subset of the components having a corresponding one or more property estimates of the property; and performing iterations of an NTF model for the one or more acoustic sources, the iterations comprising (a) combining values of a plurality of parameters of the NTF model with the computed property estimates to separate from the at least one acquired signal one or more contributions from the predetermined acoustic source.

In some embodiments, the acoustic source separation algorithm includes computing time-dependent spectral characteristics from the at least one acquired signal, the spectral characteristics comprising a plurality of components; accessing at least a first model configured to predict contributions from the predetermined acoustic source of the one or more acoustic sources; and performing iterations of an NTF model for the one or more acoustic sources, the iterations comprising running the first model to separate from the at least one acquired signal one or more contributions from the predetermined acoustic source.

In some embodiments, the acoustic source separation algorithm includes computing time-dependent spectral characteristics from the at least one acquired signal, the spectral characteristics comprising a plurality of components; computing direction estimates from at least two signals of one or more signals acquired using the one or more acoustic sensors, each computed component of the spectral characteristics having a corresponding one of the direction estimates; performing a decomposition procedure using the computed spectral characteristics and the computed direction estimates as input to identify a plurality of sources of the plurality of signals, each component of the spectral characteristics having a computed degree of association with at least one of the identified sources and each source having a computed degree of association with at least one direction estimate; and using a result of the decomposition procedure to selectively process a signal from one of the sources.

In some embodiments, the acoustic source separation algorithm includes accessing an indication of a current block size, the current block size defining a size of a portion of the at least one acquired signal to be analyzed to separate from the at least one acquired signal one or more contributions from the predetermined acoustic source of the one or more acoustic sources. The algorithm them includes analyzing a first portion of the at least one acquired signal, the first portion being of the current block size by computing one or more first characteristics from data of the first portion and using the computed one or more first characteristics, or derivatives thereof, in performing iterations of an NTF model for the one or more acoustic sources for the data of the first portion to separate, from at least the first portion of the at least one acquired signal, one or more first contributions from the predetermined acoustic source. The algorithm also includes analyzing a second portion of the at least one acquired signal, the second portion being of the current block size and being temporaly shifted with respect to the first portion by computing one or more second characteristics from data of the second portion and using the computed one or more second characteristics, or derivatives thereof, in performing iterations of the NTF model for the data of the second portion to separate, from at least the second portion of the at least one acquired signal, one or more second contributions from the predetermined acoustic source.

In some embodiments, using the sensor data may include correlating the sensor data to the at least one acquired signal.

In some embodiments, the sensor data may include data indicative of occurrence of an event or/and change of a state of a surrounding where the at least one signal is acquired.

In some embodiments, using the sensor data may include identifying a time instance or a time period of the at least one acquired signal corresponding to a time instance or a time period when the event occurred or the state of the surrounding changed, and adjusting the acoustic source separation algorithm based on the identified time instance or the time period.

In some embodiments, adjusting the acoustic source separation algorithm based on the identified time instance or the time period could include adjusting the acoustic source separation algorithm and/or noise reduction process to account for the occurrence of the event or/and the change of the state of the surrounding.

In some embodiments, the processor may further be configured to determine a location and/or an orientation of the one or more acoustic sensors and further use the determined location and/or orientation of the one or more acoustic sensors in executing the acoustic source separation algorithm.

In some embodiments, the processor may be configured to determine the location and/or the orientation of the one or more acoustic sensors based on the obtained sensor data.

As will be appreciated by one skilled in the art, aspects of the present disclosure may be embodied in various manners—e.g. as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing acoustic source separation modules or controllers of such modules, etc.) or be stored upon manufacturing of these devices and systems.

Other features and advantages will become apparent from the following detailed description and drawings.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIGS. 1A and 1B show a schematic representation of an acoustic source tracking and selection module according to some embodiments of the present disclosure.

FIG. 2 depicts a schematic representation of a semi-closed environment with an acoustic source tracking and selection module according to some embodiments of the present disclosure.

FIG. 3A depicts a schematic representation of a device with a display and an integrated acoustic source tracking and selection module according to some embodiments of the present disclosure.

FIG. 3B depicts a schematic representation of a wearable device with an integrated acoustic source tracking and selection module according to some embodiments of the present disclosure.

FIG. 3C shows a schematic representation of a handheld device with an integrated acoustic source tracking and selection module according to some embodiments of the present disclosure.

FIG. 4 shows a block diagram of an acoustic source tracking and selection module according to some embodiments of the present disclosure.

FIG. 5A shows a perspective view of a microphone array according to some embodiments of the present disclosure.

FIG. 5B shows a cross-sectional view of a microphone array according to some embodiments of the present disclosure.

FIG. 6 depicts an acoustic source tracking and selection method according to some embodiments of the present disclosure.

FIG. 7 shows an acoustic source tracking and selection method according to some embodiments of the present disclosure.

FIG. 8 is a diagram illustrating a representative client device according to some embodiments of the present disclosure.

FIG. 9 is a diagram illustrating a flow chart of method steps leading to separation of audio signals according to some embodiments of the present disclosure.

FIG. 10 is a diagram illustrating a Non-Negative Matrix Factorization (NMF) approach to representing a signal distribution according to some embodiments of the present disclosure.

FIG. 11 is a diagram illustrating a flow chart of method steps leading to separation of acoustic signals using direction data according to some embodiments of the present disclosure.

FIG. 12 is a diagram illustrating a flow chart of method steps leading to separation of acoustic signals using property estimates according to some embodiments of the present disclosure.

FIG. 13 illustrates a cloud-based blind source separation system according to some embodiments of the present disclosure.

FIGS. 14A-C illustrate how blind source separation processing may be partitioned in different ways between a local client and the cloud according to some embodiments of the disclosure.

FIG. 15 is a flowchart describing an exemplary method according to some embodiments of the present disclosure.

FIG. 16 is a flowchart representing an exemplary method for cloud based source separation according to some embodiments of the present disclosure.

### DESCRIPTION

The ability for electronic devices to listen to their environments is increasingly important. However, the audio received at electronic devices may be a combination of audio signals from a preferred acoustic source and noise from any number of other unwanted acoustic sources.

Source separation is one technique for removing noise due to unwanted acoustic sources from an audio signal. A digital signal processor (DSP) or other circuitry or software may be configured to analyze an audio signal and reduce or remove portions of the audio input identified as noise or boost portions of the audio input identified as audio signal from the desired or otherwise selected acoustic source. For example, a source separation algorithm may be designed to isolate human speech from wind and road noises heard inside a car.

Another technique for improving audio input is to use additional microphones in a microphone array. If a device has at least two microphones, and the microphone geometry (e.g., position and orientation of the microphones relative to one another) is known, a device could analyze the phase and amplitude differences in the signals received at each microphone to perform audio beamforming. Beamforming is spatial, or directional, filtering. If the device can determine the approximate direction of the audio source, it can filter out interfering audio sources coming from different directions. Increasing the number of microphones in the microphone array can provide the beamformer with additional signals to form beams more precisely. However, beamforming is also a computationally intensive process that may benefit greatly from an integrated, end-to-end solution.

In some cases, the beamformer can be fixed, such that it assumes the speaker is always oriented in a particular location or direction relative to the device. In other cases, the device can perform adaptive beamforming, steering the beam as the location of the speaker changes. In yet other situations, it is the electronic device itself, including the microphone array, that moves.

Selecting and tracking the preferred acoustic source, such as when the electronic device moves relative to the preferred acoustic source, may enhance the accuracy of a beamformer, which in turn may improve the quality of the processed audio signal from the preferred acoustic source.

For example, a person wearing a hearing aid may be having a conversation with another person. The hearing aid may have a microphone array and may even have a beamformer to focus hearing in the direction of the other person's voice. However, if the person wearing the hearing aid turns or moves, the relative orientation and position of a microphone array in the hearing aid will change in relation to the other person's voice. And if the beamformer in the hearing aid does not adapt accurately to the movement, the signal-to-noise ratio (SNR) of the hearing aid will decrease, and it may be difficult or impossible for the person wearing the hearing aid to hear the other person's voice.

As another example, a person may want to issue a voice command or dictate to a smartphone. As with the hearing aid, the smartphone may include a microphone array and may also use beamforming to improve reception of the person's voice. However, if the person moves the smartphone (e.g., rotates the device from a portrait orientation to a landscape orientation), the relative orientation and position of a microphone array in the smartphone will change in relation to the person's voice. And, as with the hearing aid, it may be difficult for the smartphone to detect the person's voice accurately if its beamformer does not adapt accurately to the smartphone's movement.

In yet another example, a car driver may want to issue a voice command or speak into a speakerphone. If a manufacturer of the car has designed and installed a microphone array in a known location of the car (e.g., embedded in the dashboard or steering column), the manufacturer may also be able to include digital signal processing circuitry or software that is aware of the specific acoustics of the car. In this sense, the car may be a semi-closed acoustic environment, which encapsulates both the microphone array and a preferred acoustic source (i.e., the driver) but also may include noises from outside the car, such as wind or road noises. In addition to noise external to the car or other semi-closed environment, there may be additional acoustics sources of noise inside the car (e.g., a passenger or a radio speaker). Also, as with the examples of the hearing aid and smartphone described above, it may be difficult for the car to detect the driver's voice accurately if its beamformer does not adapt accurately to movement. The car may be able to improve the accuracy of its beamformer if it could sense and track the position and orientation of the driver relative to the microphone array in the car.

Furthermore, the car may be able to improve the accuracy of its audio processing if it includes sound source separation algorithms adapted to the acoustics of the semi-closed environment. An acoustic model of the car may be configured to account for changes in the car that may change the car's acoustics, detecting whether, for example, certain windows are rolled down, the sunroof is open, or the windshield wipers are turned on. Sensors may be configured to communicate state information or event information to an audio processing module, which may be correlated with a change in the soundscape or acoustic environment.

An acoustic source tracking and selection system may be capable of using information from motion and position sensors to select and track the preferred acoustic source. This system may use motion or position data from motion or position sensors to perform adaptive beamforming directed at a selected acoustic source. For example, a hearing aid with an embedded or otherwise integrated acoustic source tracking and selection system may be configured to steer a beam in response to movement of the hearing aid relative to the selected acoustic source. In another example, a device such as a car with an embedded acoustic source tracking and selection system may be configured to adapt a source separation process to account for sensor state or event information correlated to changes in an acoustic environment.

The description below describes network elements, computers, and/or components of systems and methods for audio processing using an acoustic source tracking and selection module that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

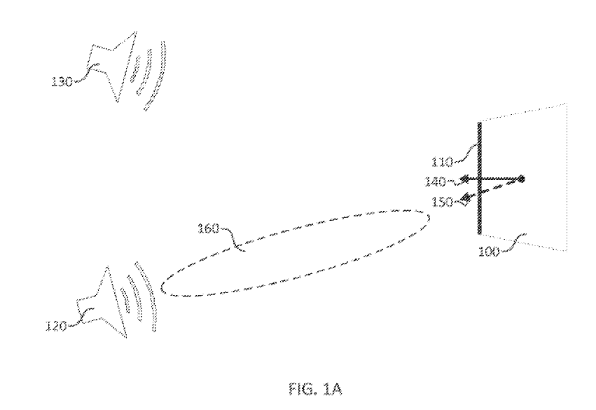

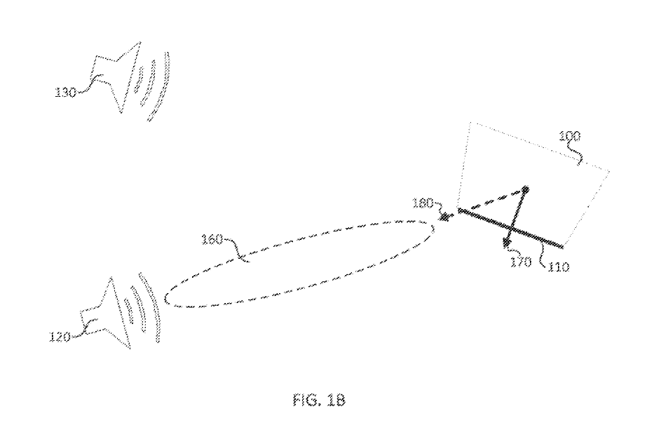

FIGS. 1A and 1B show a schematic representation of an acoustic source tracking and selection system in accordance with an embodiment of the present disclosure. As depicted in FIGS. 1A and 1B, an acoustic source tracking and selection module 100 may be situated in a particular position and in a particular orientation. In some embodiments, the acoustic source tracking and selection module 100 may be embedded or otherwise integrated in a listening device (not shown) in a particular position and orientation.

The acoustic source tracking and selection module 100 may include a microphone array 110. In some embodiments, the microphone array 110 may be situated along a side of the acoustic source tracking and selection module 100.

As shown in FIGS. 1A and 1B, a preferred acoustic source 120 may transmit an audio signal in the direction of the acoustic source tracking and selection module 100. The preferred acoustic source 120 may be a human user speaking to the acoustic source tracking and selection module 100. In other embodiments, the preferred acoustic source 120 may be any audio source (e.g., music, audio from a television show or movie, or other preferred sounds). For example, some smartphone applications are capable of listening to music or television audio to identify the song or television show, respectively.

Additionally, other audio sources, such as a noise acoustic source 130, may also be transmitting sound waves consisting of unwanted noise in the direction of the acoustic source tracking and selection module 100.

FIGS. 1A and 1B depict an overhead view of an exemplary, simplified, two-dimensional example of capabilities of the acoustic source tracking and selection module 100. Specifically, the microphone array 110 of the acoustic source tracking and selection module 100, the preferred acoustic source 120, and the noise acoustic source 130 may be coplanar, and movement of the microphone array 110 is constrained to the plane.

This example begins at an initial time with the acoustic source tracking and selection module 100 in an initial orientation 140 relative to the preferred acoustic source 120 and the noise acoustic source 130. In some embodiments, the initial orientation 140 may be based on information from position or motion sensors within, or connected to, the acoustic source tracking and selection module 100. For example, the initial orientation 140 may be based on information from a multi-axis (e.g., three-axis) accelerometer, a multi-axis (e.g., three-axis) gyroscope, or both.

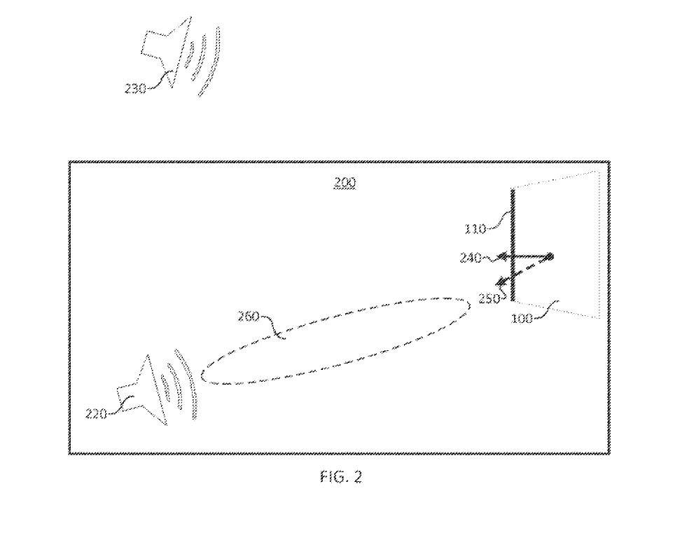

In some embodiments, the initial orientation 140 may be represented as a sequence of rigid-body rotations in three-dimensional space with a fixed coordinate system, e.g., a Tait-Bryan angle—or a “nautical angle”—with a first rotation about a first axis (e.g., “z”) by a first angle (e.g., “yaw”), a second rotation about a second axis (e.g., “x”) by a second angle (e.g., “pitch”), and a third rotation about a third axis (e.g., “y”) by a third angle (e.g., “roll”). In the two-dimensional example depicted in FIGS. 1A and 1B, the orientation may be represented by an angular coordinate (i.e., “φ”, or “θ”) in a fixed polar coordinate system. Alternatively, the example depicted in FIGS. 1A and 1B may be considered an example in three-dimensional space, in which two of the three angular coordinates (e.g., pitch and roll) remain constant between the initial time of FIG. 1A and the subsequent time of FIG. 2A, and only the third angular coordinate (e.g., yaw) changes between the initial time of FIG. 1A and the subsequent time of FIG. 2A.

The acoustic source tracking and selection module 100 may also select or otherwise determine that the preferred acoustic source 120 is the acoustic source on which to focus (e.g., form a beam). In some embodiments, initial selection of the preferred acoustic source 120 may be received as input (e.g., user input). In other embodiments, initial selection of the preferred acoustic source 120 may be performed automatically by the acoustic source tracking and selection module 100. For example, the acoustic source tracking and selection module 100 may analyze a sample of combined audio input to identify a likely direction of a preferred type of audio signal (e.g., any human speaker, or the loudest human speaker in range of the acoustic source tracking and selection module 100). In yet other embodiments, selection of the preferred acoustic source 120 may be performed in whole or in part based on information from other types of sensors. For example, a camera may provide an image of surroundings of the acoustic source tracking and selection module 100 to a face detection system (or, e.g., a lip-sensing system or lip-reading system) to determine the initial likely direction of the preferred type of audio signal (e.g., any human speaker, or the closest human speaker in the field of vision of the acoustic source tracking and selection module 100).

The acoustic source tracking and selection module 100 may also determine an initial direction 150 of the preferred acoustic source 120. In some embodiments, the acoustic source tracking and selection module 100 may also determine an initial distance (not shown) (e.g., based on a three-dimensional vector xî+yĵ+z\hat{k}, or a radial coordinate “r” in the polar coordinate system).

The acoustic source tracking and selection module 100 may be configured to form a beam along the initial direction 150 of the preferred acoustic source 120. In FIG. 1A, initial beam region 160 indicates a direction or region within which a beam may be steered or a lobe of the beam may be located. Beamforming in the initial direction of the preferred acoustic source 120 may improve the reception of the audio signal from the preferred acoustic source 120. Additionally, other acoustic sources that are not in the direction of beam, such as noise acoustic source 130, may be at least partially filtered (i.e., spatially filtered) from the audio input.

FIG. 1B shows the same two-dimensional frame (or, alternatively, the same overhead projection view of the three-dimensional scene) of FIG. 1A at a subsequent time. During a subsequent time, the acoustic source tracking and selection module 100 may determine a subsequent orientation 170 based on subsequent information from motion sensors or position sensors. During the time between FIGS. 1A and 1B, the acoustic source tracking and selection module 100 rotated about an axis perpendicular to the plane (e.g., yaw) by a measurable number of degrees (or radians). Based on this motion or position information, the acoustic source tracking and selection module 100 may estimate or otherwise determine a subsequent direction 180 (or change in direction) of the preferred acoustic source 120. In some embodiments, the acoustic source tracking and selection module 100 may also determine a subsequent distance (or change in distance) (not shown) of the preferred acoustic source 120.

In the example of FIGS. 1A and 1B, preferred acoustic source 120 remained stationary, and the subsequent direction 180 that may have been estimated or otherwise determined by the acoustic source tracking and selection module 100 approximately equals the actual current direction of the preferred acoustic source 120. In other cases (not shown), the preferred acoustic source 120 may have also moved. The acoustic source tracking and selection module 100 may sense or otherwise determine movement of the preferred acoustic source 120 to compensate for that motion as well. In such cases, movement information for the acoustic source tracking and selection module 100 may augment or otherwise enhance movement information for the preferred acoustic source 120, or vice versa.

As shown in FIG. 1B, the acoustic source tracking and selection module 100 may be configured to form the beam along the subsequent direction 180 of the preferred acoustic source 120 (relative to the subsequent orientation 170 of the acoustic source tracking and selection module 100). In this example, in which preferred acoustic source 120 has remained stationary, and the acoustic source tracking and selection module 100 has rotated about a perpendicular axis, the subsequent direction 180 equals the initial direction 150 relative to the coordinate system of the frame (or scene). Thus, the acoustic source tracking and selection module 100 may continue steering the beam in the initial region 160 as shown in both FIGS. 1A and 1B.

In some embodiments, the amount of time that passes between FIGS. 1A and 1B may be a predetermined interval at which data from the motion or position sensors is polled by the acoustic source tracking and selection module 100. In other embodiments, the amount of time that passes is a variable amount of time based on when the acoustic source tracking and selection module 100 receives a notification that the position or orientation of the acoustic source tracking and selection module 100 has changed by at least a threshold amount. In the simplified example depicted in FIGS. 1A and 1B, the amount of movement is relatively large for illustrative purposes. In practice, the amount of movement based on polling time slices or based on threshold movements may be substantially smaller, e.g., times of less than one second, or less than one-tenth of one second, etc., or movements of less than one degree of rotation, or less than one-tenth of one degree of rotation, etc.

Referring to FIG. 2, the acoustic source tracking and selection module 100 may be embedded, integrated, or otherwise attached to an interior of an at least semi-closed system 200. For example, the semi-closed system 200 may be a car or other automobile. An interior preferred acoustic source 220 may be within semi-closed system 200. For example, the interior preferred acoustic source 220 may be a driver of the car. Other acoustic sources that are within the range of the acoustic source tracking and selection module 100 may be located inside or outside the semi-closed system 200 (e.g., exterior noise acoustic source 230).

As explained above with reference to FIGS. 1A and 1B, the acoustic source tracking and selection module 100 may include a microphone array 110 along a side of the acoustic source tracking and selection module 100. Using motion and position information, the acoustic source tracking and selection module 100 may be configured to determine an interior direction 250 of the interior preferred acoustic source 220 relative to an interior orientation 240 of the acoustic source tracking and selection module 100 within the semi-closed system 200.

The acoustic source tracking and selection module 100 may also be configured to form a beam along the interior direction 250 toward the interior preferred acoustic source (e.g., within the interior region 260) based on information from motion sensors, position sensors, or other sensors.

In some embodiments, the semi-closed system 200 may include additional sensors (not shown) located at various positions within the semi-closed system 200 and that are communicatively coupled to the acoustic source tracking and selection module 100 via a wired or wireless interface. In the example of the car, the acoustic source tracking and selection module 100 may receive information about the state of the car (e.g., whether the windows are rolled down, whether the sunroof is open, or whether the windshield wipers are turned on). In some embodiments of this example, the acoustic source tracking and selection module 100 may also receive information about passengers within the car (e.g., whether the passenger air bag is engaged, whether the driver's seat belt is fastened, or whether the radio is turned on). In yet other embodiments of this example, the acoustic source tracking and selection module 100 may receive information about the driver from other sensors (e.g., cameras and face- or lip-detection information, or various capacitive sensors in the headliner of the car).

In some embodiments, sensor data, such as state information from a sensor (e.g., whether a car window is open or closed) or event information (e.g., car window is opening, or car window is closing) may be communicated to the acoustic source tracking and selection module 100. This sensor data may be correlated to audio signals received by the acoustic source tracking and selection module 100 so as to, for example, improve a source separation process.

For example, if a car driver opens or closes a window, the acoustic source tracking and selection module 100 may receive a notification from a sensor that the window is being opened or has been opened, or the acoustic source tracking and selection module 100 may periodically poll a sensor to determine the state of the window (e.g., open or closed). Concurrently, the acoustic source tracking and selection module 100 may be processing audio received at the microphone array module 410. The acoustic source tracking and selection module 100 may be configured to correlate, annotate, or otherwise identify that a particular time (or time period) of the received audio corresponds to the time at which (or the time period during which) the window state changed or window event occurred. If the car driver has opened the window at a particular time (e.g., 11:30 AM), and the soundscape or acoustic environment changed at approximately the same time, the acoustic source tracking and selection module 100 may attribute the change in the soundscape to the window opening event. In some embodiments, the acoustic source tracking and selection module 100 may determine that a particular audio source (e.g., noise from outside the car) grew louder when the window was opened and, for example, adjust a source separation process, or adjust a noise reduction process, or other audio processing technique, to account for the recently opened window.

In some embodiments, acoustic properties or an acoustic model of the semi-closed system 200 may be known. The acoustic source tracking and selection module 100 may use information from motion sensors or other sensors in conjunction with the known acoustic properties or acoustic model to enhance or otherwise augment the processing of the audio input.

In other embodiments, the acoustic source tracking and selection module 100 may be within the interior of the semi-closed system 200 but not necessarily in a fixed position. For example, the acoustic source tracking and selection module 100 may be embedded within a smartphone configured to adapt its source tracking and selection capabilities based on whether it is within the interior of the semi-closed system 200, or how the acoustic source tracking and selection module 100 is oriented or located within various points within the interior of the semi-closed system 200. In the example of a car, the smartphone may be configured to detect whether it is inside the car. In some embodiments, the smartphone may be configured to determine where within the car it is located (e.g., engaged with a mounting apparatus on the dashboard or placed in a central console cup holder). In some embodiments, the smartphone may include sensors for determining where within the car it is located. In other embodiments, the smartphone may receive this information from the car based on sensors of the car (e.g., a cup holder sensor).

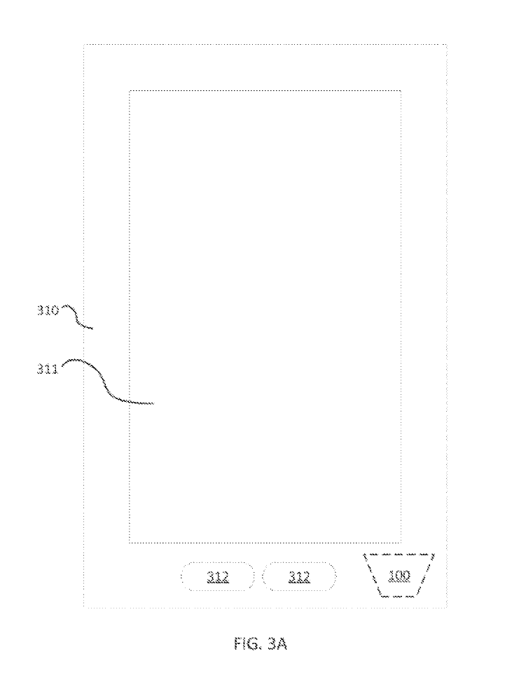

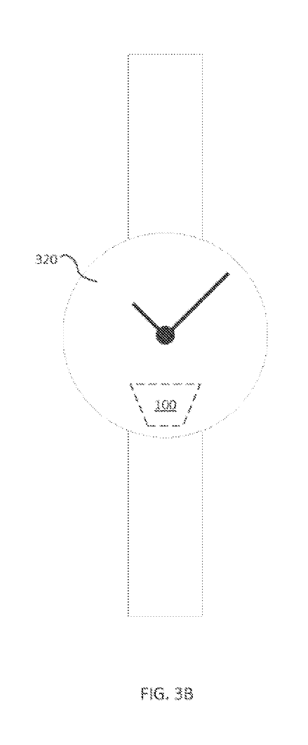

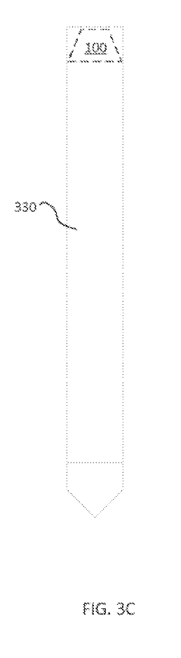

Referring to FIGS. 3A, 3B, and 3C, the acoustic source tracking and selection module 100 may be embedded or otherwise attached to a variety of devices and systems. FIGS. 3A, 3B, and 3C depict exemplary schematic representations of devices embedded with acoustic source tracking and selection modules in accordance with embodiments of the present disclosure.

In FIG. 3A, a display-based device 310 is shown with embedded acoustic source tracking and selection module 100. In the embodiment of FIG. 3A, the display-based device 310 is a smartphone, including display 311 and buttons 313. In other embodiments, the display-based device 310 may be a tablet, phablet, laptop, or other mobile computing device, or any other device with a display including, but not limited to, a television, computer, or other display. The display-based device 310 may be configured to display information related to the digital audio signals processed by the acoustic source tracking and selection module 100. For example, the acoustic source tracking and selection module 100 may receive speech input that an ASR service interprets as a query (e.g., “What is the weather today?”), and the display-based device 310 may be configured to display the text of the query (e.g., “What is the weather today?”) or the results of the query (e.g., 70 degrees Fahrenheit and sunny).

In FIG. 3B, a wearable device 320 is shown with embedded acoustic source tracking and selection module 100. In the embodiment of FIG. 3B, the wearable device 320 is a watch. In other embodiments, the wearable device 320 may be a hearing aid, fitness tracking bracelet or device, headset, clothing, eyewear, or any other wearable device designed to receive and process audio signals. The wearable device 320 may include a display or other screen that may be similar to the display-based device 310.

In FIG. 3C, a handheld device 330 is shown with embedded acoustic source tracking and selection module 100. In the embodiment of FIG. 3C, the handheld device 330 is a pen. In other embodiments, the handheld device 330 may be a wand, key fob, or any other handheld device designed to receive and process audio signals. The handheld device 330 may include the option of being worn similar to the wearable device 330, or it may include a display or other screen that may be similar to the display-based device 310.

The embodiments and preceding descriptions of FIGS. 3A, 3B, and 3C are merely exemplary and not limiting of the present disclosure. In other embodiments (not shown), the acoustic source tracking and selection module 100 may be embedded or otherwise attached in various other form factors and types of devices. For example, the acoustic source tracking and selection module 100 may be embedded in a car, bicycle, or other mobile vehicle, fitness equipment, appliances (e.g., refrigerators, microwaves, thermostats), or any other suitably connected electronic device designed to receive audio input.

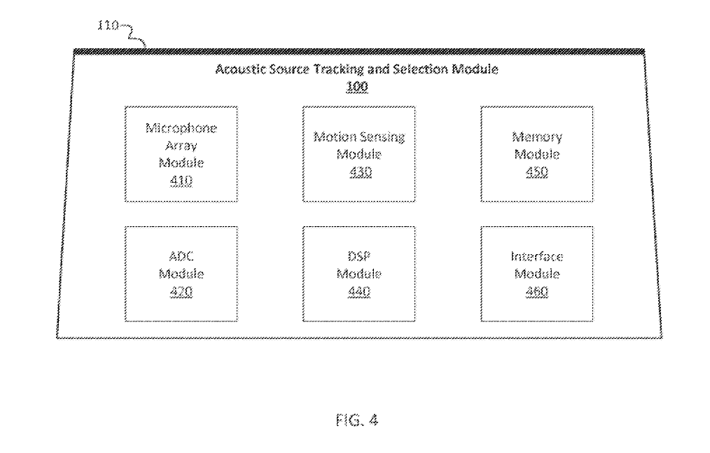

Referring to FIG. 4, an acoustic source tracking and selection module 100 (e.g., the acoustic source tracking and selection module 100 depicted in FIGS. 1A, 1B, 2, and 3A-3C), may include several integrated components to select and track preferred acoustic sources, as well as to process analog audio input from at least one preferred acoustic source. For example, the audio input may include human speech and may be processed into recognized speech or voice commands for an embedding device (e.g., semi-closed system 200, display-based device 310, wearable device 320, handheld device 330, etc.). FIG. 4 shows a block diagram of an acoustic source tracking and selection module 100 in accordance with an embodiment of the present disclosure. As illustrated, the acoustic source tracking and selection module 100 may include one or more components including microphone array module 410 (including, e.g., the microphone array 110 as described above), analog-to-digital converter (ADC) module 420, motion sensing module 430, digital signal processor (DSP) module 440, memory module 450, and interface module 460.

The acoustic source tracking and selection module 100 may be a single package or microchip including an application-specific integrated circuit (ASIC), or integrated circuits, which implement(s) the modules 410 to 460. In some embodiments, acoustic source tracking and selection module 100 may include a printed circuit board. The printed circuit board may include one or more discrete components, such as an array of microphones (not shown) in microphone array module 410, or an antenna or input/output pins (not shown) in interface module 460. One or more integrated circuits may be assembled on the printed circuit board and permanently soldered or otherwise affixed to the printed circuit board. In other embodiments, the package or the discrete elements may be interchangeably attached to the printed circuit board to promote repairs, customizations, or upgrades. The acoustic source tracking and selection module 100 may be contained within a housing or chassis.

The acoustic source tracking and selection module 100 may be configured to be embedded within another device or system. In other embodiments, the acoustic source tracking and selection module 100 may be configured to be portable or interchangeably interface with multiple devices or systems.

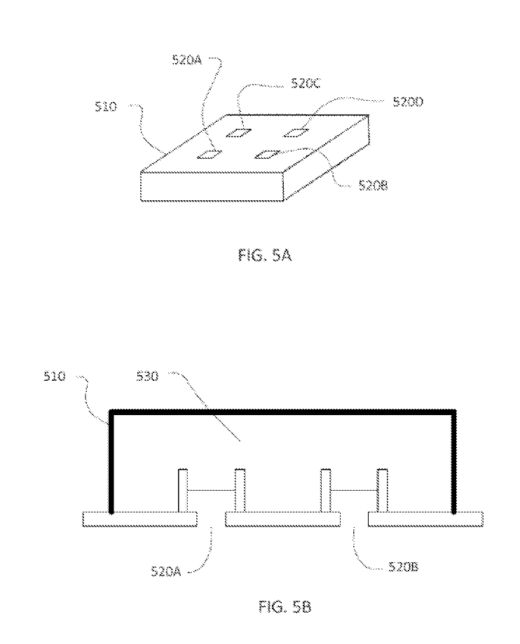

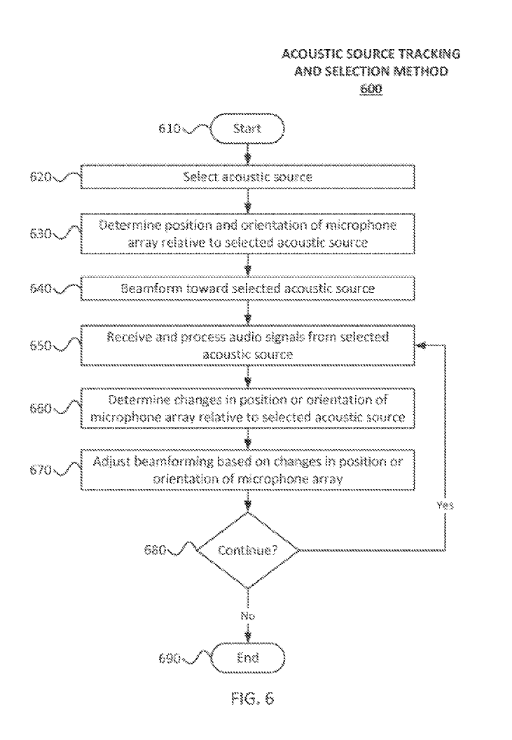

According to some embodiments, the microphone array module 410 may include at least two microphone elements arranged according to a predetermined geometry, spacing, or orientation. For example, as described herein with reference to FIGS. 5A and 5B, the microphone array module 410 may be a quad microphone with four microphone elements. The microphone elements of the microphone array module 410 may be spaced apart sufficient to detect measurable differences in the phases or amplitudes of the audio signals received at each of the microphone elements. In other embodiments, the acoustic source tracking and selection module 100 may include a single microphone element instead of an array of multiple microphone elements such as microphone array module 410.

In some embodiments, the microphone array module 410 may include microelectromechanical systems (MEMS) microphones such as Analog Devices ADMP504. The MEMS microphones may be analog or digital, and they may include other integrated circuits such as amplifiers, filters, power management circuits, oscillators, channel selection circuits, or other circuits configured to complement the operation of the MEMS transducers or other microphone elements.

The microphone elements of the microphone array module 410 may be of any suitable composition for detecting sound waves. For example, microphone array module 410 may include transducers and other sensor elements. The transducer elements may be configured for positioning at ports on the exterior of a device or system.

The microphone array module 410 may be in electrical communication with analog-to-digital converter (ADC) circuitry of ADC module 420. ADCs may convert analog audio signals received by the microphone array module 410 into digital audio signals. Each microphone element of the microphone array of microphone array module 410 may be connected to a dedicated ADC integrated circuit of ADC module 420, or multiple microphone elements may be connected to a channel of a multi-channel ADC integrated circuit (not shown). ADC circuits may be configured with any suitable resolution (e.g., a 12-bit resolution, a 24-bit resolution, or a resolution higher than 24 bits). The format of the digital audio signals output from ADC module 420 may be any suitable format (e.g., a pulse-density modulated (PDM) format, a pulse-code modulated (PCM) format). ADC module 420 may connect to a bus interface, such as Integrated Interchip Sound (I²S) electrical serial bus. In some embodiments, ADC module 420 may be specially configured, customized, or designed to convert the known range of analog audio signals received by the microphone elements of the microphone array module 410 because the ADC module 420 and the microphone array module 410 are components of an integrated acoustic source tracking and selection module 100.

In addition to sensing audio input at the microphone array module 410, the acoustic source tracking and selection module 100 may also be configured to sense motion (or position and orientation) information from motion sensing module 430. In other embodiments, motion sensing and data pre-processing may be performed by a motion coprocessor module (not shown).

Motion sensing module 430 may include sensors (not shown) such as a multi-axis (e.g., three-axis) accelerometer, a multi-axis (e.g., three-axis) gyroscope, or both.

An accelerometer of the motion sensing module 430 or the motion sensing module 430 may be a micro-machined capacitive, or MEMS, accelerometer. The accelerometer may function as an orientation or motion sensor by measuring acceleration along one or more axes due to gravity (i.e., g-force acceleration). A three-axis accelerometer may be capable of sensing orientation or changes in orientation in three-dimensions within the Earth's gravitational field.

A gyroscope (e.g., a solid-state or MEMS gyroscope) may be present in the motion sensing module 430 or the motion sensing module 430. The gyroscope may measure orientation based on angular momentum about one or more axes.

Together, a three-axis accelerometer and a three-axis gyroscope can provide enhanced motion sensing with six degrees of freedom (or six components), including acceleration in three-dimensional space (e.g., rigid-body translation) and rotation in three-dimensional space (e.g., roll, pitch, and yaw).

The foregoing descriptions of the accelerometer and the gyroscope are merely exemplary. Other sensors instead of, or in addition to, the aforementioned sensors may be present in other embodiments. For example, a magnetometer of the motion sensing module 430 or motion sensing module 430 may be a solid-state magnetometer (e.g., a magnetoresistive permalloy sensor or a Hall Effect sensor). The magnetometer may function as a compass for the acoustic source tracking and selection module 100 by sensing voltages proportional to an applied magnetic field (e.g., Earth's magnetic field). A three-axis magnetometer may be capable of sensing compass direction independent of the orientation (or elevation) of the acoustic source tracking and selection module 100. Information from other sensors, including, but not limited to, tilt sensors, inclinometers, altimeters, etc. may be included.

Digital audio signals converted by ADC circuits may be communicated to a processor, such as a digital signal processor (DSP) in the DSP module 440. Information from the motion sensing module 430 may also be communicated to a processor such as the DSP in the DSP module 440. DSP module 440 may be configured with any DSP or other processor suitable for processing the digital audio signals that it receives. DSP module 440 may execute instructions for processing the digital audio signals.

The instructions may be configured to cause the DSP to perform acoustic source tracking and selection. For example, the DSP may be configured to perform beamforming, adapting the direction of the beam based on the information from the motion sensor module 430. In some embodiments, the DSP may be configured to perform source separation. Source separation techniques may be adapted or adjusted to account for state or event information received from other sensors, which may be embedded within the acoustic source tracking and selection module 100 or, in some embodiments, external to the acoustic source tracking and selection module 100.

These examples are not limiting, and it is within the scope of the present disclosure for the DSP to perform any available digital audio signal routine or algorithm for processing, improving, or enhancing the digital audio signals. The acoustic source tracking and selection module 100 may be configured to receive updated or upgraded instructions to include new or improved digital audio signal processing routines or algorithms.

DSP module 440 may also be configured to perform power management or power saving functions. For example, if the acoustic source tracking and selection module 100 is not in use, DSP module 440 may enter a low-power (e.g., sleep or standby) state. The acoustic source tracking and selection module 100 may include other sensors (e.g., buttons, switches, motion activation, voice or keyword activation) to determine whether DSP module 440 should enter or leave the low-power state. In other embodiments, acoustic source tracking and selection module 100 may receive electrical signals from a device or system indicating that the DSP module 440 should enter or leave the low-power state.

In some embodiments, DSP module 440 or the instructions executed by DSP module 440 may be specially configured, customized, designed, or programmed to process the known quality and quantity of digital audio signals that it receives from ADC module 420 because DSP module 440 and ADC module 420 may be components of an integrated acoustic source tracking and selection module 100. For example, DSP module 440 may be specially configured to perform beamforming for a known geometry of the microphone module 410. In some embodiments in which the microphone module 410 is a quad microphone (e.g., the quad microphone depicted in FIGS. 5A and 5B), DSP module 440 may be configured to perform beamforming by processing four streams of digital audio signals for each of four microphone elements arranged in a known geometry of the quad microphone.

In some embodiments, DSP module 440 or the instructions executed by DSP module 440 may perform some or all of the audio processing within the acoustic source tracking and selection module 100. In some embodiments, DSP module 440 may offload some of the audio processing to other integrated circuitry of the acoustic source tracking and selection module 100. For example, acoustic source tracking and selection module 100 may include a source separation module (not shown) that includes integrated circuits for separating or otherwise isolating audio sources from the digital audio signals that may represent a combination of audio sources.

Other examples of audio processing that may be performed by DSP module 400 include, but are not limited to, automatic calibration, noise removal (e.g., wind noise or noise from other sources), automatic gain control, high-pass filtering, low-pass filtering, clipping reduction, Crest factor reduction, or other preprocessing or post-processing functionality.

DSP module 440 may receive instructions to execute from an integrated memory module such as memory module 450. Memory module 450 may be any suitable non-transitory processor readable medium for storing instructions, such as non-volatile flash memory. In some embodiments, memory module 450 may include a read only memory (ROM) module. In other embodiments, memory module 450 may include rewritable memory that may receive updates or upgrades to the firmware or other instructions. The type, speed, or capacity of memory module 450 may be specially configured, customized, or designed for the firmware or other instructions to be executed by DSP module 440 because memory module 450 and DSP module 440 may be components of an integrated acoustic source tracking and selection module 100. In some embodiments, such as the example of a car as a semi-closed system 200, which is described above with reference to FIG. 2.

In some embodiments, the acoustic source tracking and selection module 100 may perform automatic speech recognition (ASR). ASR may be performed by DSP module 440 or a separately integrated ASR module (not shown). In these embodiments, memory module 450 may be further configured to store information related to performing ASR, including, but not limited to, ASR dictionaries, ASR neural networks, and ASR coefficients.

Additionally, the acoustic source tracking and selection module 100 may include an interface module 460 that includes one or more interfaces for communicating processed digital audio signals or other signals between the acoustic source tracking and selection module 100 and another device or system. For example, in some embodiments, interface module 460 may include wired interfaces such as pin-outs of a package or bus connectors (e.g., a standard Universal Serial Bus (USB) connector or an Ethernet port). In other embodiments, interface module 460 may include wireless interfaces such as IEEE 802.11 Wi-Fi, Bluetooth, or cellular network standard interfaces such as 4G, 4G, or LTE wireless connectivity. Interface module 460 may be configured to communicate with an electrically connected device in which the acoustic source tracking and selection module 100 is embedded or otherwise attached. In other embodiments, interface module 460 may be configured to communicate with remote or cloud-based resources such as an ASR service. Interface module 460 may be configured or designed to accommodate a variety of ports or customized for particular circuit boards to accommodate different devices.

With reference to FIG. 5A, the microphone array module 410 may be a quad microphone 510 with four microphone elements (e.g., microphone elements 520A-D). The four microphone elements 520A-D may be arranged according to a known geometry. For example, the four microphone elements 520A-D may be arranged in a square configuration (as shown). In other embodiments, the four microphone elements 520A-D may be arranged serially or linearly, or the four microphone elements 520A-D may be arranged in a circular or rectangular configuration, or any other suitable configuration.

The known geometry may also include a known size and spacing of the four microphone elements 520A-D. For example, the four microphone elements 520A-D may form a 1.5 mm², 2 mm², or other suitably sized configuration.

With reference to FIG. 5B, each of the four microphone elements 520A-D may share a common backvolume 530. In other embodiments, each microphone element 520A, 520B, 520C, and 520D may be configured to use an individually partitioned backvolume.

FIG. 6 depicts an acoustic source tracking and selection method 600 in accordance with an embodiment of the present disclosure. At block 610, the method may begin.

At block 620, an acoustic source (e.g., preferred acoustic source 120) may be selected. In some embodiments, selection may be made at least in part based on input received from an external source such as user input or input received via sensors of other devices. Also, in some embodiments, selection may be made at least in part automatically. Automatic selection may be made based in part on, for example, determine a loudest or closest human speaker within range of a microphone array (e.g., microphone array 110).

At block 630, information about the position and orientation of the microphone array relative to the selected acoustic source may be determined. In some embodiments, the microphone array may be coupled or otherwise integrated as part of an acoustic source tracking and selection module (e.g., acoustic source tracking and selection module 100). The acoustic source tracking and selection module may also include a motion sensing module (e.g., motion sensing module 430). The motion sensing module may include one or more sensors for sensing information about the position or orientation of the microphone array, such as accelerometers, gyroscopes, etc. In other embodiments, the position and orientation information may be determined, at least in part, based on information received from devices or sensors communicatively coupled to the acoustic source tracking and selection module.

At block 640, an acoustic beam may be beamformed toward the selected acoustic source. In some embodiments, beamforming may be performed by a digital signal processor or other integrated circuitry (e.g., DSP module 440). Beamforming may be based on the position and orientation information obtained at block 630. Additionally, beamforming may account for the specific predetermined geometry of the microphone array, such as a quad microphone in a square configuration of known dimensions.

At block 650, audio signals from the selected acoustic source may be received (at, e.g., microphone array 110) and processed (by, e.g., acoustic source tracking and selection module 100, including, for example, DSP module 440). In some embodiments, the audio signals may be separated from noise from other acoustic sources (e.g., noise acoustic source 130) using source separation circuitry or other similar techniques. In other embodiments, noise from other acoustic sources may be at least partially filtered out (e.g., spatially filtered) based on the beamforming described above in reference to block 640.

At block 660, changes in the position or orientation of the microphone array relative to the selected acoustic source (e.g., motion or movement of the microphone array or the acoustic source tracking and selection module) may be determined. In some embodiments, the changes may be determined by at least some of the same components that were used to determine the initial position and orientation at block 630 (e.g., motion sensing module 430).

At block 670, the acoustic beam may be steered or otherwise formed toward the selected acoustic source based at least in part on the changes in the position or orientation of the microphone array relative to the selected acoustic source that were determined at block 650. In some embodiments, the selected acoustic source may remain stationary. In other embodiments, the selected acoustic source may have also moved from its initial position or orientation relative to the microphone array.

At block 680, a determination may be made as to whether there is more audio input to receive and process. If yes, the method 600 may return to block 650 for further processing. If no, the method 600 may end at block 690. For example, a signal may be received that indicates a low-power or sleep mode, in which case the method 600 may end at block 690.

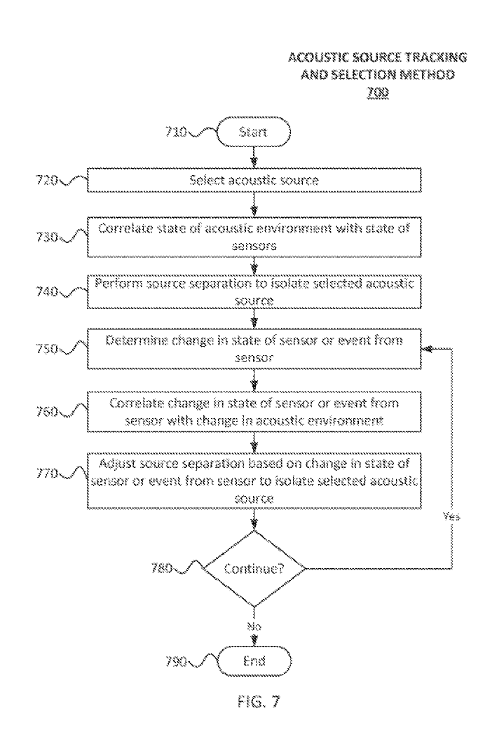

FIG. 7 shows another acoustic source tracking and selection method 700 in accordance with an embodiment of the present disclosure. At block 710, the method may begin.

At block 720, an acoustic source (e.g., preferred acoustic source 120) may be selected. In some embodiments, selection may be made at least in part based on input received from an external source such as user input or input received via sensors of other devices. Also, in some embodiments, selection may be made at least in part automatically. Automatic selection may be made based in part on, for example, determining a loudest or closest human speaker within range of a microphone array (e.g., microphone array 110).

At block 730, in some embodiments, information about the state of a soundscape or acoustic environment may be correlated with state information about one or more sensors. For example, the acoustic source tracking and selection module 100 may determine that a car window is open. Consequently, the acoustic source tracking and selection module 100 may account for the window being open to perform source selection or other audio processing techniques such as noise reduction.

At block 740, source separation may be performed to isolate the selected acoustic source or reduce noise. In some embodiments, audio signals from the selected acoustic source may be received (at, e.g., microphone array 110) and processed (by, e.g., acoustic source tracking and selection module 100, including, for example, DSP module 440). In some embodiments, the audio signals may be separated from noise from other acoustic sources (e.g., noise acoustic source 130) using source separation circuitry or other similar techniques. In other embodiments, noise from other acoustic sources may be at least partially filtered out (e.g., spatially filtered) based on the beamforming described above in reference to block 640 (FIG. 6).

At block 750, a change in a state of a sensor may be determined, or information about an event may be received from a sensor. For example, the acoustic source tracking and selection module 100 may receive a notification about an event (e.g., that a car window is being opened or closed, or the acoustic source tracking and selection module 100 may determine state information (e.g., that a car window is presently open or closed).

At block 760, a change in a state of a sensor or event information determined at block 750 may be correlated with a change in an acoustic environment (or soundscape). In some embodiments, the correlation may be performed by at least some of the same components that were used to perform the initial correlation of the acoustic environment with a state of one or more sensors at block (730).

At block 770, a source separation process may be adjusted based on the correlation determined at block 760 (e.g., between the received sensor information and the received audio signals) to isolate (or improve isolation of) the selected acoustic source. In other embodiments, the selected acoustic source and the microphone array may have also moved relative to one another from their initial relative positions or orientations.

At block 780, a determination may be made as to whether there is more audio input to receive and process. If yes, the method 700 may return to block 750 for further processing. If no, the method 700 may end at block 790. For example, a signal may be received that indicates a low-power or sleep mode, in which case the method 600 may end at block 690.

In some embodiments, multiple instances of methods 600 or 700 or other portions of methods 600 or 700 may be executed in parallel. For example, sound waves may be received at four microphone elements of a microphone array 310, and the four streams of analog audio signals may be converted to digital analog signals simultaneously. In another example, beamforming may be adjusted based on changes in position or orientation of the microphone array at block 670 at the same time or approximately the same as a source separation process is being adjusted based on a change in state of a sensor or event information received from the sensor to, for example, isolate the selected acoustic source within the soundscape or acoustic environment.

In some embodiments, methods 600 or 700 may be configured for a pipeline architecture. For example, a first portion of a digital audio signal may be processed at block 640, and, at the same time, a second portion of motion data may be received to facilitate beamforming at block 630 for the next portion of the digital audio signal.

Audio processing using acoustic source tracking and selection in accordance with the present disclosure as described above may involve the processing of input data and the generation of output data to some extent. This input data processing and output data generation may be implemented in hardware or software. For example, specific electronic components may be employed in an acoustic source tracking and selection module or similar or related circuitry for implementing the functions associated with acoustic source tracking and selection in accordance with the present disclosure as described above. Alternatively, one or more processors operating in accordance with instructions may implement the functions associated with acoustic source tracking and selection in accordance with the present disclosure as described above. If such is the case, such instructions may be stored on one or more non-transitory processor readable storage media (e.g., a magnetic disk or other storage medium), such as memory module 150, or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

### Various Source Separation Techniques

A number of techniques have been developed for source separation from a single microphone signal, including techniques that make use of time versus frequency decompositions. A process of performing the source separation without any prior information about the acoustic signals is often referred to as “blind source separation” (BSS).

Some BSS techniques make use of Non-Negative Matrix Factorization (NMF). Some BSS techniques have been applied to situations in which multiple microphone signals are available, for example, with widely spaced microphones.

Various aspects of the present disclosure relate to different BSS techniques and are described in the following context, unless specified otherwise.

There is at least one acoustic sensor configured to acquire an acoustic signal. The signal typically has contributions from a plurality of different acoustic sources, where, as used herein, the term “contribution of an acoustic source” refers to at least a portion of an acoustic signal generated by the acoustic source, typically the portion being a portion of a particular frequency or a range of frequencies, at a particular time or range of times. When an acoustic source is e.g. a person speaking, there will be multiple contributions, i.e. there will be acoustic signals of different frequencies at different times generated by such a “source.”

In some embodiments a plurality of acoustic sensors, arranged e.g. in a sensor array, are configured to acquire such signals (i.e., each acoustic sensor acquires a corresponding signal). In some embodiments where a plurality of acoustic sensors are employed, the sensors may be provided relatively close to one another, e.g. less than 2 centimeters (cm) apart, preferably less than 1 cm apart. In an embodiment, the sensors may be arranged separated by distances that are much smaller, on the order of e.g. 1 millimeter (mm) or about 300 times than typical sound wavelength, where beamforming techniques, used e.g. for determining direction of arrival (DOA) of an acoustic signal, do not apply. While some embodiments where a plurality of acoustic sensors are employed make a distinction between the signals acquired by different sensors (e.g. for the purpose of determining DOA by e.g. comparing the phases of the different signals), other embodiments may consider the plurality of signals acquired by an array of acoustic sensors as a single signal, possibly by combining the individual acquired signals into a single signal as is appropriate for a particular implementation. Therefore, in the following, when an “acquired signal” is discussed in a singular form, then, unless otherwise specified, it is to be understood that the signal may comprise several acquired signals acquired by different sensors.

The different BSS techniques presented herein are based on computing time-dependent spectral characteristics X of the acquired signal. A characteristic could e.g. be a quantity indicative of a magnitude of the acquired signal. A characteristic is “spectral” in that it is computed for a particular frequency or a range of frequencies. A characteristic is “time-dependent” in that it may have different values at different times.

In an embodiment, such characteristics may be a Short Time Fourier Transform (STFT), computed as follows. An acquired signal is functionally divided into overlapping blocks, referred to herein as “frames.” For example, frames may be of a duration of 64 milliseconds (ms) and be overlapping by e.g. 48 ms. The portion of the acquired signal within a frame is then multiplied with a window function (i.e. a window function is applied to the frames) to smooth the edges. As is known in signal processing, and in particular in spectral analysis, the term “window function” (also known as tapering or apodization function) refers to a mathematical function that has values equal to or close to zero outside of a particular interval. The values outside the interval do not have to be identically zero, as long as the product of the window multiplied by its argument is square integrable, and, more specifically, that the function goes sufficiently rapidly toward zero. In typical applications, the window functions used are non-negative smooth “bell-shaped” curves, though rectangle, triangle, and other functions can be used. For instance, a function that is constant inside the interval and zero elsewhere is called a “rectangular window,” referring to the shape of its graphical representation. Next, a transformation function, such as e.g. Fast Fourier Transform (FFT), is applied transforming the waveform multiplied by the window function from a time domain to a frequency domain. As a result, a frequency decomposition of a portion of the acquired signal within each frame is obtained. The frequency decomposition of all of the frames may be arranged in a matrix where frames and frequency are indexed (in the following, frames are described to be indexed by “n” and frequencies are described to be indexed by “f”). Each element of such an array, indexed by (f,n) comprises a complex value resulting from the application of the transformation function and is referred to herein as a “time-frequency bin” or simply “bin.” The term “bin” may be viewed as indicative of the fact that such a matrix may be considered as comprising a plurality of bins into which the signal's energy is distributed. In an embodiment, the bins may be considered to contain not complex values but positive real quantities X(f,n) of the complex values, such quantities representing magnitudes of the acquired signal, presented e.g. as an actual magnitude, a squared magnitude, or as a compressive transformation of a magnitude, such as a square root.

Time-frequency bins come into play in BSS algorithms in that separation of a particular acoustic signal of interest (i.e. an acoustic signal generated by a particular source of interest) from the total signal acquired by an acoustic sensor may be achieved by identifying which bins correspond to the signal of interest, i.e. when and at which frequencies the signal of interest is active. Once such bins are identified, the total acquired signal may be masked by zeroing out the undesired time-frequency bins. Such an approach would be called a “hard mask.” Applying a so-called “soft mask” is also possible, the soft mask scaling the magnitude of each bin by some amount. Then an inverse transformation function (e.g. inverse STFT) may be applied to obtain the desired separated signal of interest in the time domain. Thus, masking in the frequency domain (i.e. in the domain of the transformation function) corresponds to applying a time-varying frequency-selective filter in the time domain.

The desired separated signal of interest may then be selectively processed for various purposes.

In some aspects, various approaches to processing of acoustic signals acquired at a user's device include one or both of acquisition of parallel signals from a set of closely spaced microphones, and use of a multi-tier computing where some processing is performed at the user's device and further processing is performed at one or more server computers in communication with the user's device. The acquired signals are processed using time versus frequency estimates of both energy content as well as direction of arrival. In some examples, intermediate processing data, e.g. characterizing direction of arrival information, may be passed from the user's device to a server computer where direction-based processing is performed.

One or more aspects of the present disclosure address a technical problem of providing accurate processing of acquired acoustic signals within the limits of computation capacity of a user's device. An approach of performing the processing of the acquired acoustic signals at the user's device permits reduction of the amount of data that needs to be transmitted to a server computer for further processing. Use of the server computer for the further processing, often involving speech recognition, permits use of greater computation resources (e.g., processor speed, runtime and permanent storage capacity, etc.) that may be available at the server computer.

In such a context, different computer-implemented methods outlining various BSS techniques described herein are now summarized. Each of the methods may be performed by one or more processing units, such as e.g. one or more processing units at a user's device and/or one or more processing units at one or more server computers in communication with the user's device.

One aspect of the present disclosure provides a first method for processing a plurality of signals acquired using a corresponding plurality of acoustic sensors, where the signals have contributions from a plurality of different acoustic sources. The first method is referred to herein as a “basic NTF” method. One step of the first method includes computing time-dependent spectral characteristics (e.g. quantities X representing a magnitude of the acquired signals) from at least one signal of the plurality of acquired signals. The computed spectral characteristics comprise a plurality of components, e.g. each component may be viewed as a value of X(f,n) assigned to a respective bin (f,n) of the plurality of time-frequency bins. The first method also comprises a step of computing direction estimates D from at least two signals of the plurality of acquired signals, each component of a first subset of the plurality of components having a corresponding one or more of the direction estimates. Thus, each time-frequency bin of a first subset of bins has a corresponding one or more direction estimates, where direction estimates either indicate possible direction of arrival of the component or indicate directions that are to be excluded from the possible direction of arrivals—i.e. directions that are definitely inappropriate/impossible can be ruled out. The first method further includes a step of performing iterations of a nonnegative tensor factorization (NTF) model for the plurality of acoustic sources, the iterations comprising a) combining values of a plurality of parameters of the NTF model with the computed direction estimates to separate from the acquired signals one or more contributions from a first acoustic source (s₁) of the plurality of acoustic sources.

As used in the present disclosure, unless otherwise specified, referring to a “subset” of the plurality of components is used to indicate that not all of the components need to be analyzed, e.g. to compute direction estimates. For example, some components may correspond to bins containing data that is too noisy to be analyzed. Such bins may then be excluded from the analysis.

In an embodiment of the first method, step (a) described above may include combining values of the plurality of parameters of the NTF model with the computed direction estimates to generate, using the NTF model, for each acoustic source of the plurality of acoustic sources, a spectrogram of the acoustic source (i.e., spectrogram estimating frequency contributions of the source). In one further embodiment of the first method, the step of performing the iterations may include comprises performing iterations of not only step (a) but also steps (b) and (c), where step (b) includes, for each acoustic source of the plurality of acoustic sources, scaling a portion of the spectrogram of the acoustic source corresponding to each component of a second subset of the plurality of components by a corresponding scaling factor to generate a scaled spectrogram of the acoustic source and step (c) includes updating values of at least some of the plurality of parameters based on the scaled spectrograms of the plurality of acoustic source.

It is to be understood that, as used in the present disclosure, the term “spectrogram” does not necessarily imply an actual spectrogram but any data indicative of at least a portion of such a spectrogram, providing a representation of the spectrum of frequencies in an acoustic signal as they vary with time or some other variable.

In an embodiment of the first method, the plurality of parameters used by the NTF model may include a direction distribution parameter q(d|s) indicating, for each acoustic source of the plurality of acoustic sources, probability that the acoustic source comprises (e.g. generates or has generated) one or more contributions in each of a plurality of the computed direction estimates.

In an embodiment, the first method may further include combining the computed spectral characteristics with the computed direction estimates to form a data structure representing a distribution indexed by time, frequency, and direction. Such a data structure may be a sparse data structure in which a majority of the entries of the distribution are absent or set to some predetermined value that is not taken into consideration when running the method. The NTF may then be performed using the formed data structure.

Another aspect of the present disclosure provides a second method for processing at least one signal acquired using a corresponding acoustic sensor, where the signal has contributions from a plurality of different acoustic sources. The second method is referred to herein as an “NTF with NN redux” method. One step of the second method includes computing time-dependent spectral characteristics (e.g. quantities X representing a magnitude of the acquired signals) from at least one signal of the plurality of acquired signals. Similar to the first method, the computed spectral characteristics comprise a plurality of components, e.g. each component may be viewed as a value of X(f,n) assigned to a respective bin (f,n) of the plurality of time-frequency bins. The second method also comprises a step of applying a first model to the time-dependent spectral characteristics, the first model configured to compute property estimates of a predefined property. Each component of a first subset of the components has a corresponding one or more property estimates of the predefined property (i.e., each time-frequency bin has a corresponding one or more likelihood estimates, where likelihood estimate either indicates how likely it is that the mass in that bin corresponds to a certain value of the property. For example, if the property is “direction,” the value could be e.g. “north by northeast”, “southwest”, or “perpendicular the plane of the microphone array.” In another example, if the property is “speech-like,” then the value could be e.g. “yes”, “no”, “probably.” The second method further includes a step of performing iterations of an NTF model for the plurality of acoustic sources, the iterations comprising a) combining values of a plurality of parameters of the NTF model with the computed property estimates to separate from the acquired signal one or more contributions from the first acoustic source.

In an embodiment of the second method, the following steps may be iterated: (a) combining values of the plurality of parameters of the NTF model with the computed property estimates to generate, using the NTF model, for each acoustic source, a spectrogram of the acoustic source, (b) for each acoustic source, scaling a portion of the spectrogram of the acoustic source corresponding to each component of a second subset of the plurality of components by a corresponding scaling factor to generate a scaled spectrogram of the acoustic source, and (c) updating values of at least some of the plurality of parameters based on the scaled spectrograms of the plurality of acoustic sources.

In an embodiment of the second method, the plurality of parameters used by the NTF model may include a property distribution parameter q(g|s) indicating, for each acoustic source of the plurality of acoustic sources, probability that the acoustic source comprises (e.g. generates or has generated) one or more contributions in each of a plurality of the computed property estimates.

In various embodiments, such a predefined property may include a direction of arrival, a component comprising a contribution from a specified acoustic source of interest, etc.

In an embodiment of the second method, the first model may be any classifier configured (e.g. designed and/or trained) to predict value(s) of the property. For example, the first model could comprise a neural network model, such as e.g. a deep neural net (DNN) model, a recurrent neural net (RNN) model, or a long short-term memory (LSTM) net model.

In an embodiment, the second method may further include combining the computed spectral characteristics with the computed property estimates to form a data structure representing a distribution indexed by time, frequency, and direction. Such a data structure may be a sparse data structure in which a majority of the entries of the distribution are absent or set to some predetermined value that is not taken into consideration when running the method. The NTF may then be performed using the formed data structure.

Yet another aspect of the present disclosure provides a third method for processing at least one signal acquired using a corresponding acoustic sensor, where the signal has contributions from a plurality of different acoustic sources. The third method is referred to herein as an “NN NTF” method. One step of the third method includes computing time-dependent spectral characteristics (e.g. quantities X representing a magnitude of the acquired signals) from at least one signal of the plurality of acquired signals. Similar to the first and second method, the computed spectral characteristics comprise a plurality of components, e.g. each component may be viewed as a value of X(f,n) assigned to a respective bin (f,n) of the plurality of time-frequency bins. The third method also comprises steps of accessing at least a first model configured to predict contributions from a first acoustic source of the plurality of acoustic sources, and performing iterations of an NTF model for the plurality of acoustic sources, the iterations comprising running the first model to separate from the at least one acquired signal one or more contributions from the first acoustic source.

In an embodiment of the third method, the following steps may be iterated: (a) combining values of the plurality of parameters of the first NTF model to generate, using the NTF model, for each acoustic source of the plurality of acoustic sources, a spectrogram of the acoustic source (i.e., spectrogram estimating frequency contributions of the source), (b) for each acoustic source, scaling a portion of the spectrogram of the acoustic source corresponding to each component of a first subset of the plurality of components by a corresponding scaling factor to generate a scaled spectrogram of the acoustic source, and (c) running the first model using at least a portion of the scaled spectrogram as an input to the first model to update values of at least some of the plurality of parameters.

In an embodiment, the third method may further use direction data. In such an embodiment, at least one further signal is acquired using a corresponding further acoustic sensor, the method further includes computing direction estimates D from the two acquired signals, each component of a second subset of the plurality of components having a corresponding one or more of the direction estimates, and the spectrogram for each acoustic source is generated by combining the values of the plurality of parameters of the NTF model with the computed direction estimates.

In one further embodiment of the third method where the direction data is used, the plurality of parameters used by the NTF model may include a direction distribution parameter q(d|s) indicating, for each acoustic source of the plurality of acoustic sources, probability that the acoustic source comprises (e.g. generates or has generated) one or more contributions in each of a plurality of the computed direction estimates.

In an embodiment, the third method may be combined with the second method, resulting in what is referred to herein as a “NN NTF with NN redux” method. In such an embodiment, the third method further includes a step of applying a second model to the time-dependent spectral characteristics, the second model configured to compute property estimates G of a predefined property, each component of a third subset of the components having a corresponding one or more property estimates of the predefined property. In such an embodiment, the spectrogram is generated by combining the values of the plurality of parameters of the NTF model with the computed property estimates.

In an embodiment of the NN NTF with NN redux method, the plurality of parameters used by the NTF model may include a property distribution parameter q(g|s) indicating, for each acoustic source, probability that the acoustic source comprises (e.g. generates or has generated) one or more contributions in each of a plurality of the computed property estimates. In various further embodiments, such a predefined property may include a direction of arrival, a component comprising a contribution from a specified acoustic source of interest, etc.

In various embodiments of the third method, each of the first and the second models may be any classifier configured (e.g. designed and/or trained) to predict value(s) of the property. For example, each of the first and the second models could comprise a neural network model, such as e.g. a DNN model, an RNN model, or an LSTM net model. The first and the second models may, but do not have to, be the same models.

In each of an embodiment of the first method and an embodiment of the third method where the direction data is used, the step of computing the direction estimates of a component may include computing data representing one or more directions of arrival of the component in the acquired signals. In one further embodiment, computing the data representing the direction of arrival may include one or both of computing data representing one or more directions of arrival and computing data representing an exclusion of at least one direction of arrival. Alternatively or additionally, computing the data representing the direction of arrival may include determining one or more optimized directions associated with the component using at least one of phases and times of arrivals of the acquired signals, where determination of the optimized one or more directions may include performing at least one of a pseudo-inverse calculation and a least-square-error estimation.

In various embodiments, each of the first, second, and third methods may further include steps of using the values of the plurality of parameters of the NTF model following completion of the iterations to generate a mask Mₛ₁ for identifying the one or more contributions from the first acoustic source s₁ to the time-dependent spectral characteristics X, and applying the generated mask Mₛ₁ to the time-dependent spectral characteristics X to separate the one or more contributions from the first acoustic source.

In various embodiments, each of the first, second, and third methods may further include a step of initializing the plurality of parameters of the NTF model by assigning a value of each parameter to an initial value.

In various embodiments, each of the first, second, and third methods may further include a step of applying a transformation function to transform at least portions of the at least one signal of the plurality of acquired signals from a time domain to a frequency domain, where the time-dependent spectral characteristics are computed based on an outcome of applying the transformation function. Each of these methods may further include a step of applying an inverse transformation function to transform the separated one or more contributions from the first acoustic source to the time domain. In various further embodiments, the transformation function may be an FFT. In another further embodiment, each component of the plurality of components of the spectral characteristics may comprise a value of the spectral characteristic associated with a different range of frequencies and with a different time range (i.e., each component comprises spectral characteristics assigned to a particular time-frequency bin). In yet another further embodiment, the spectral characteristics may include values indicative of magnitudes of the at least one signal of the plurality of acquired signals.

In an embodiment of each of the first, second, and third methods, each component of the plurality of components of the time-dependent spectral characteristics may be associated with a time frame of a plurality of successive time frames.

In an embodiment of each of the first, second, and third methods, each component of the plurality of components of the time-dependent spectral characteristics may be associated with a frequency range, whereby the computed components form a time-frequency characterization of the at least one acquired signal.

In an embodiment of each of the first, second, and third methods, each component of the plurality of components of the time-dependent spectral characteristics may represent energy of the at least one acquired signal at a corresponding range of time and frequency.

In another aspect, in general, yet a method for processing a plurality of signals acquired uses a corresponding plurality of acoustic sensors at a client device. The signals have parts from a plurality of spatially distributed acoustic sources. The method comprises: computing, using a processor at the client device, time-dependent spectral characteristics from at least one signal of the plurality of acquired signals, the spectral characteristics comprising a plurality of components; computing, using the processor at the client device, direction estimates from at least two signals of the plurality of acquired signals, each computed component of the spectral characteristics having a corresponding one of the direction estimates; performing a decomposition procedure using the computed spectral characteristics and the computed direction estimates as input to identify a plurality of sources of the plurality of signals, each component of the spectral characteristics having a computed degree of association with at least one of the identified sources and each source having a computed degree of association with at least one direction estimate; and using a result of the decomposition procedure to selectively process a signal from one of the sources.

Each component of the plurality of components of the time-dependent spectral characteristics computed from the acquire signals is associated with a time frame of a plurality of successive time frames. For example, each component of the plurality of components of the time-dependent spectral characteristics computed from the acquired signals is associated with a frequency range, whereby the computed components form a time-frequency characterization of the acquired signals. In at least some examples, each component represents energy (e.g., via a monotonic function, such as square root) at a corresponding range of time and frequency.

Computing the direction estimates of component comprises computing data representing a direction of arrival of the component in the acquired signals. For example, computing the data representing the directional of arrival comprises at least one of (a) computing data representing one direction of arrival, and (b) computing data representing an exclusion of at least one direction of arrival. As another example, computing the data representing the direction of arrival comprises determining an optimized direction associated with the component using at least one of (a) phases, and (b) times of arrivals of the acquired signals. The determining of the optimized direction may comprise performing at least one of (a) a pseudo-inverse calculation, and (b) a least-squared-error estimation. Computing the data representing the direction of arrival may comprise computing at least one of (a) an angle representation of the direction of arrival, (b) a direction vector representation of the direction of arrival, and (c) a quantized representation of the direction of arrival.

Performing the decomposing comprises combining the computed spectral characteristics and the computed direction estimates to form a data structure representing a distribution indexed by time, frequency, and direction. For example, the method may comprise performing a non-negative matrix or tensor factorization using the formed data structure. In some examples, forming the data structure comprises forming data structure representing a sparse data structure in which a majority of the entries of the distribution are absent.

Performing the decomposition comprises determining the result including a degree of association of each component with a corresponding source. In some examples, the degree of association comprises a binary degree of association.

Using the result of the decomposition to selectively process the signal from one of the sources comprises forming a time signal as an estimate of a part of the acquired signals corresponding to said source. For example, forming the time signal comprises using the computed degrees of association of the components with the identified sources to form said time signal.

Using the result of the decomposition to selectively process the signal from one of the sources comprises performing an automatic speech recognition using an estimated part of the acquired signals corresponding to said source.

At least part of performing the decomposition process and using the result of the decomposition procedure is performed as a server computing system in data communication with the client device. For example, the method further comprises communicating from the client device to the server computing system at least one of (a) the direction estimates, (b) a result of the decomposition procedure, and (c) a signal formed using a result of the decomposition as an estimate of a part of the acquired signals. In some examples, the method further comprises communicating a result of the using of the result of the decomposition procedure from the server computing system to the client device. In some examples, the method further comprises communicating data from the server computing system to the client device for use in performing the decomposition procedure at the client device.

In still another aspect of the present disclosure, another method for processing at least one signal acquired using an acoustic sensor is provided, the method referred to herein as a “streaming NTF.” Again, the at least one signal has contributions from a plurality of acoustic sources. The streaming NTF method includes steps of accessing an indication of a current block size, the current block size defining a size of a portion (referred to herein as a “block”) of the at least one signal to be analyzed to separate from the at least one signal one or more contributions from a first acoustic source of the plurality of acoustic sources and analyzing a first and a second portions of the at least one signal. The second portion is temporaly shifted (i.e., shifted in time) with respect to the first portion. In one embodiment, both the first and the second portions are portions of the current block size. In other embodiments, the first and second portions may be of different sizes. The first portion is analyzed by computing one or more first characteristics from data of the first portion, and using the computed one or more first characteristics, or derivatives thereof, in performing iterations of an NTF model for the plurality of acoustic sources for the data of the first portion to separate, from at least the first portion of the at least one acquired signal, one or more first contributions from the first acoustic source. The second portion is analyzed by computing one or more second characteristics from data of the second portion, and using the computed one or more second characteristics, or derivatives thereof, in performing iterations of the NTF model for the data of the second portion to separate, from at least the second portion of the at least one acquired signal, one or more second contributions from the first acoustic source.

In various embodiments of the streaming NTF method, accessing the indication of the current block size may include either receiving user input providing the indication of the current block size or a derivative thereof or computing the current block size based on one or more factors, such as e.g. one or more of the amount of unprocessed data available (in a networked setting this might be variable), the amount of processing resources available such as processor cycles, main memory, cache memory, or register memory, and acceptable latency for the current application.

In an embodiment of the streaming NTF method, the first portion and the second portion may overlap in time.

In an embodiment of the streaming NTF method, past statistics about previous iterations of the NTF model (for earlier blocks) may be advantageously taken into consideration. In such an embodiment, the method may further include using one or more past statistics computed from data of a past portion of the at least one signal in performing the iterations of the NTF model for the data of the first portion and/or for the data of the second portion, where the past portion may include a portion of the at least one signal that has been analyzed to separate from the at least one signal one or more contributions from the first acoustic source.

In an embodiment of the streaming NTF method, the past portion may comprise a plurality of portions of the at least one signal, each portion of the plurality of portions being of the current block size, and the one or more past statistics from the data of the past portion may comprise a combination of one or more characteristics computed from data of each portion of the plurality of portions and/or results of performing iterations of the NTF model for the data of the each portion. In this manner, the past summary statistics may be a combination of statistics from analyzing various blocks. In one further embodiment, the plurality of portions may overlap in time.

In an embodiment of the streaming NTF method, the method may further include storing information indicative of one or more of: the one or more first characteristics, results of performing iterations of the NTF model for the data of the first portion, the one or more second characteristics, and results of performing iterations of the NTF model for the data of the second portion as a part of the one or more past characteristics. In this manner, past statistics may be accumulated. In an embodiment, computing the past statistics involves adding some NTF parameters from the most recent runs of the NTF model to the statistics available before that time (i.e., the previous past statistics). In an embodiment, accumulating past statistics goes beyond merely storing the NTF parameters, but involve compute some kind of derivative based on these parameters. In addition to the items listed above, in an embodiment, the computed past characteristics may further depend on the previous past characteristics.

In various embodiments, streaming NTF approach is applicable to a conventional NMF approach for source separation as well as to any of the source separation methods described herein, such as e.g. the basic NTF, NN NTF, basic NTF with NN redux, and NN NTF with NN redux.

In an embodiment of any of the methods described herein, a first subset of the steps of any of the methods may be performed by a client device and a second subset of the steps may be performed by a server. In such an embodiment, the method includes performing, at the client device, the first subset of the steps, providing, from the client device to the server, at least a part of an outcome of performing the first subset of the steps, and at least partially based on the at least part of the outcome provided from the client device, performing, at the server, the second subset of the steps. In an embodiment, the first subset and the second subset of the steps may be overlapping (i.e. a step or a part of a step of a particular method may be performed by both the client device and the server).

In another aspect, in general, a signal processing system, which comprises a processor and an acoustic sensor having one or more sensor elements, is configured to perform all the steps of any one of methods set forth above.

In another aspect, in general, a signal processing system comprises an acoustic sensor, integrated in a client device, device possibly having multiple sensor elements, and a processor also integrated in the client device. The processor of the client device is configured to perform at least some of the steps of any one of methods described herein. The rest of the steps may be performed by a processor integrated in a remote device, such as e.g. a server. In such examples, the system further comprises a communication interface that enables communication between the client device and the server and allows the client device and the server to exchange, as needed, results of their respective processing. In an embodiment, a step or a part of a step of a particular method may be performed by both the client device and the server.

Furthermore, the present disclosure includes apparatus, systems, and computerized methods for providing cloud-based blind source separation services carrying out any of the source separation processing steps described herein, such as, but not limited to, the source separation processing steps in accordance with the basic NTF, NN NTF, basic NTF with NN redux, NN NTF with NN redux, and streaming NTF methods, and any combinations of these methods.

One computerized method for providing source separation includes steps of receiving, by a computing device, partially-processed acoustic data from a client device, the data having at least one component of source-separation processing already completed prior to the data being received; processing, by the computing device, the partially-processed acoustic data to generate source-separated data; and providing, by the computing device, the generated source-separated data for acoustic signal processing. In accordance with some aspects, the computing device may comprise a distributed computing system communicating with the client device over a network.

Embodiments may also include, prior to receiving partially-processed acoustic data from a client device, identifying a plurality of source-separation processing steps; and allocating each of the identified source-separation processing steps as to either the client device or a cloud computing device, wherein the at least one component of source-separation processing already completed prior to the data being received comprises the identified source-separation processing steps allocated to the client device, and wherein further processing comprises executing the identified processing steps allocated to the cloud computing device.

Some aspects may determine at least one instruction by means of the acoustic signal processing. The instruction may be provided to the client device and/or to a third party device for execution.

In accordance with some aspects, the at least one component of source-separation processing already completed may include at least one of ambient noise reduction, feature identification, and compression.

In accordance with some aspects, the further processing may be carried out using data collected from a plurality of sources other than the client device. The further processing may include comparing the received data to a plurality of samples of acoustic data; and for each sample, providing an evaluation of the confidence that the sample matches the received data. The further processing may include applying a hierarchical model to identify one or more features of the received data.

In another embodiment, a computerized method for providing source separation includes steps of: receiving, by a cloud computing device, acoustic data from a client device; processing, by the cloud computing device, the acoustic data to generate source-separated data; and providing, by the computing device, the generated source-separated data for acoustic signal processing.

In accordance with some aspects, processing the acoustic data may include using distributed processing over a plurality of processers in order to process the data.

In accordance with some aspects, processing the acoustic data may include using a template database including a plurality of audio samples in order to process the data.

### Exemplary Setting for Acquisition of Audio Signals

Use of spoken input for user devices, e.g. smartphones, can be challenging due to presence of other sound sources. BSS techniques aim to separate a sound generated by a particular source of interest from a mixture of various sounds. Various BSS techniques disclosed herein are based on recognition that providing additional information that is considered within iterations of an nonnegative matrix factorization (NMF) model, thus making a model a nonnegative tensor factorization model due to the presence of at least one extra dimension in the model (hence, “tensor” instead of “matrix”), improves accuracy and efficiency of source separation. Examples of such information include direction estimates or neural network models trained to recognize a particular sound of interest. Furthermore, identifying and processing incremental changes to an NTF model, rather than re-processing the entire model each time data changes, provides an efficient and fast manner for performing source separation on large sets of quickly changing data. Carrying out at least parts of BSS techniques in a cloud allows flexible utilization of local and remote resources.

In general, embodiments described herein are directed to a problem of acquiring a set of audio signals, which typically represent a combination of signals from multiple sources, and processing the signals to separate out a signal of a particular source of interest, or multiple signals of interest, from other undesired signals. At least some of the embodiments are directed to the problem of separating out the signal of interest for the purpose of automated speech recognition when the acquired signals include a speech utterance of interest as well as interfering speech and/or non-speech signals. Other embodiments are directed to problem of enhancement of the audio signal for presentation to a human listener. Yet other embodiments are directed for other forms of automated speech processing, for example, speaker verification or voice-based search queries.

Embodiments also include one or both of (a) carrying out the source separation methods are described herein, and (b) processing the audio signals in a multi-tier architecture in which different parts of the processing may be performed on different computing devices, for example, in a client-server arrangement. It should be understood that these two aspects are independent and that some embodiments may carry out the source separation methods on a single computing device, and that other embodiments may not carry out the source separation methods, but may nevertheless use a multi-tier architecture. Finally, at least some embodiments may neither use directional information nor multi-tier architectures, for example, using only time-frequency factorization approaches described below.

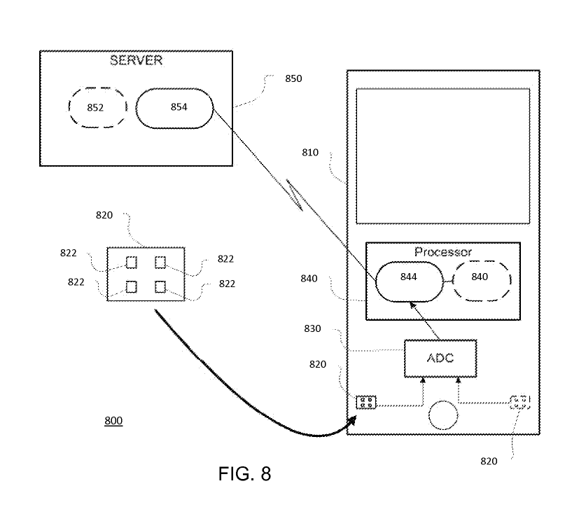

Referring to FIG. 8, features that may be present in various embodiments are described in the context of an exemplary embodiment in which one or more client devices, such as e.g. personal computing devices, specifically smartphones 810 (only one of which is shown in FIG. 8) include one or more microphones 820, each of which has multiple closely spaced elements (e.g., 1.5 mm, 2 mm, 3 mm spacing). The analog signals acquired at the microphone(s) 820 are provided to an Analog-to-Digital Converter (ADC) 830, which, in turn, provides digitized audio signals acquired at the microphone(s) 820 to a processor 840 coupled to the ADC 830. The processor includes a storage/memory 842, which is used in part for data representing the acquired acoustic signals, and a processing unit 844 which implements various procedures described below.

In an embodiment, the smartphone 810 may be coupled to a server 850 over any kind of network that offers communicative interface between clients such as client devices, e.g. the smartphone 810, and servers such as e.g. the server 850. In various embodiments, such a network could be a cellular data network, any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology.

The server also includes a storage 852 and a CPU 854. In various embodiments, data may be exchanged between the smartphone and the server during and/or immediately following the processing of the audio signals acquired at the smartphone. For example, partially processed audio signals are passed from the smartphone to the server, and results of further processing (e.g., results of automated speech recognition) are passed back from the server to the smartphone. In an embodiment, the partially processed audio signals may merely comprise acquired audio signals being converted into digital signals by the ADC 820. In another example, the server 850 may be configured to provide data to the smartphone, e.g. estimated directionality information or spectral prototypes for the sources, which may be used by the processor 840 of the smartphone to fully or partially process audio signals acquired at the smartphone.

It should be understood that a smartphone application is only one of a variety of examples of client devices. In various embodiments, the device 810 may be any device, such as e.g. an audio signal acquisition device integrated in a vehicle. Furthermore, while the device 810 is referred to herein as a “client device”, in various embodiments, such a device may or may not be operated by a human user. For example, the device 810 could be any device participating in machine-to-machine (M2M) communication where differentiation between the acoustic sources may be desired.

In one embodiment, the multiple element microphone 820 may acquire multiple parallel audio signals. For example, the microphone may acquire four parallel audio signals from closely spaced elements 822 (e.g., spaced less than 2 mm apart) and passes these as analog signals (e.g., electric or optical signals on separate wires or fibers, or multiplexed on a common wire or fiber) x₁(t), . . . , x₄(t) to the ADC 830.

Separating an Audio Mixture into Component Sources

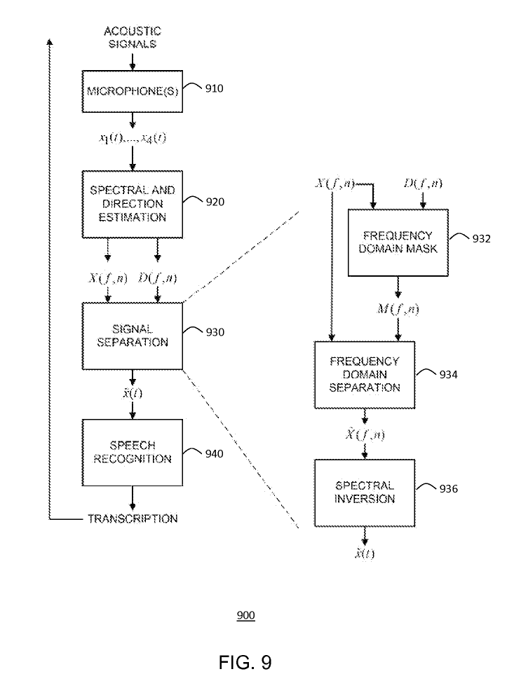

FIG. 9 is a diagram illustrating a flow chart 900 of method steps leading to separation of audio signals, according to an embodiment of the present disclosure.

As shown in FIG. 9, the method 900 may begin with a step 910 where acoustic signals are received by the microphone(s) 820, resulting in signals x₁(t), . . . , x₄(t) corresponding to the four microphone elements 822 shown in an exemplary illustration of FIG. 8 (of course, teachings described herein are applicable to any number of microphone elements). Each of the signals x₁(t), . . . , x₄(t) represents a mixture of the acoustic signals, as detected by the respective microphone element 822. Digitized signals x₁(t), . . . , x₄(t) generated in step 910 are passed to a processor, e.g. to a local processing unit such as the processing unit 844 and/or to a remote processing unit such as the processing unit 854, for signal processing.

In step 920, the processing unit performs spectral estimation and direction estimation, described in greater detail below, thereby producing magnitude and direction information X(f,n) and D(f,n), where f is an index over frequency bins and n is an index over time intervals (i.e., frames). As used herein, the term “direction estimate” refers to any representation of a direction such as, but not limited to, a single direction or at least some representation of direction that excludes certain directions or renders certain directions to be substantially unlikely.

The information generated in step 920 is then used in a signal separation step 930 to produce one or more separated time signals \tilde{x}(t), thereby separating the audio mixture received in step 910 into component sources. The one or more separated signals produced in step 930 may, optionally, be passed to a speech recognition step 940, e.g. to produce a transcription.

### Spectral and Direction Estimation

Step 920 is now described in greater detail.

In general, processing of the acquired audio signals includes performing a time frequency analysis from which positive real quantities X(f,n) representing magnitudes of the signals may be derived. For example, Short-Time Fourier Transform (STFT) analysis may be performed on the time signals in each of a series of time windows (“frames”) shifted 30 milliseconds (ms) per increment with 1024 frequency bins, yielding 1024 complex quantities per frame for each input signal. When presented in a polar form, each complex quantity represents the magnitude of the signal and the angle, or the phase, of the signal. In some implementations, one of the input signals may be chosen as a representative, and the quantity X(f,n) may be derived from the STFT analysis of the time signal, with the angle of the complex quantities being retained for later reconstruction of a separated time signal. In some implementations, rather than choosing a representative input signal, a combination (e.g., weighted average or the output of a linear beam former based on previous direction estimates) of the time signals or their STFT representations is used for forming X(f,n) and the associated phase quantities.

In various embodiments, positive real quantities X(f,n) representing magnitudes of the signals could be presented in various manners, not only as an actual magnitude, but also e.g. as a squared magnitude, or as a compressive transformation of the magnitude, such as a square root. Unless specified otherwise, description of the quantities X(f,n) as representing magnitudes is applicable to any kind of magnitude representation.

In addition to the magnitude-related information, direction-of-arrival (DOA) information is computed from the time signals, also indexed by frequency and frame. For example, continuous incidence angle estimates D(f,n), which may be represented as a scalar or a multi-dimensional vector, are derived from the phase differences of the STFT.

An example of a particular direction of arrival calculation approach is as follows. The geometry of the microphones is known a priori and therefore a linear equation for the phase of a signal each microphone can be represented as \vec{a}ₖ□\vec{d}+δ₀=δₖ, where \vec{a}ₖ is the three-dimensional position of the k^{th} microphone, \vec{d} is a three-dimensional vector in the direction of arrival, δ₀ is a fixed delay common to all the microphones, and δₖ=φₖ/ωᵢ is the delay observed at the k^{th} microphone for the frequency component at frequency ω₁ computed from the phase φₖ of the complex STFT of the k^{th} microphone. The equations of the multiple microphones can be expressed as a matrix equation Ax=b where A is a K×4 matrix (K is the number of microphones) that depends on the positions of the microphones, x represent the direction of arrival (a 4-dimensional vector having \vec{d} augmented with a unit element), and b is a vector that represents the observed K phases. This equation can be solved uniquely when there are four non-coplanar microphones. If there are a different number of microphones or this independence isn't satisfied, the system can be solved in a least squares sense. For fixed geometry the pseudoinverse P of A can be computed once (e.g., as a property of the physical arrangement of ports on the microphone) and hardcoded into computation modules that implement an estimation of direction of arrival x as Pb. The direction D is then available directly from the vector direction x. In some examples, the magnitude of the direction vector x, which should be consistent with (e.g., equal to) the speed of sound, is used to determine a confidence score for the direction, for example, representing low confidence if the magnitude is inconsistent with the speed of sound. In some examples, the direction of arrival is quantized (i.e., binned) using a fixed set of directions (e.g., 20 bins), or using an adapted set of directions consistent with the long-term distribution of observed directions of arrival.

Note that the use of the pseudo-inverse approach to estimating direction information is only one example, which is suited to the situation in which the microphone elements are closely spaced, thereby reducing the effects of phase “wrapping.” In other embodiments, at least some pairs of microphone elements may be more widely spaced, for example, in a rectangular arrangement with 36 mm ad 63 mm spacing. In such an arrangement, and alternative embodiment makes use of techniques of direction estimation (e.g., linear least squares estimation) as e.g. described in International Application Publication WO2014/047025, titled “SOURCE SEPARATION USING A CIRCULAR MODEL.” In yet other embodiments, a phase unwrapping approach is applied in combination with a pseudo-inverse approach as described above, for example, using an unwrapping approach to yield approximate delay estimates, followed by application of a pseudo-inverse approach. Of course, one skilled in the art would understand that yet other approaches to processing the signals (and in particular processing phase information of the signals) to yield a direction estimate can be used.

### Source Separation According to Basic NTF

There are many ways in which step 930 may be carried out according to various embodiments of the present disclosure. Those representing what is referred to herein as a “basic Nonnegative Tensor Factorization (NTF)” are now described in greater detail. The word “basic” in the expression “basic NTF” is used to highlight the difference from other NTF-based implementations described herein, in particular a Neural Net (NN) NTF, NTF with NN Redux, NN NTF with NN Redux, and Streaming NTF.

Continuing to refer to FIG. 9, one implementation of the signal separation stage 930 may involve first performing a frequency domain mask step 932, which produces a mask M(f,n). This mask is then used in step 934 to perform signal separation in the frequency domain producing \tilde{X}(f,n), which is then passed to a spectral inversion stage 936 in which the time signal \tilde{x}(t) is determined for example using an inverse transform. Note that in FIG. 9, the flow of the phase information (i.e., the angle of complex quantities indexed by frequency f and time frame n) associated with X(f,n) and \tilde{X}(f,n) is not shown.

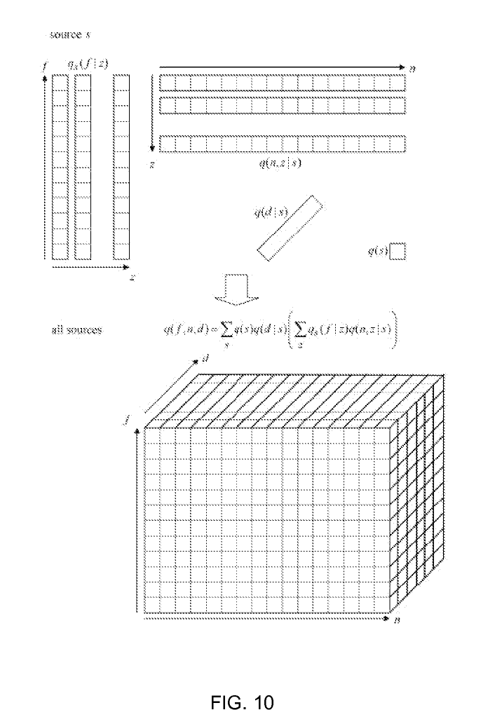

As discussed more fully below, different embodiments implement the signal separation stage 930 in somewhat different ways. Referring to FIG. 10, one approach involves treating using the computed magnitude and direction information from the acquired signals as a distribution

$$p ( f , n , d ) = p ( f , n ) p ( d \vert f , n )$$

$$where$$

$$p ( f , n ) = ( \frac{X ( f , n )}{{\sum }_{{f}^{′} , {n}^{′}} X ( {f}^{′} , {n}^{′} )} )$$

$$and$$

$$p ( d \vert f , n ) = \{ \begin{matrix}1 & if D ( f , n ) = d \\ 0 & otherwise\end{matrix}$$

Notation “distribution (A|B)” is used to describe a distribution with respect to A for a given B. For example p (d|f,n) is used to describe a probability distribution over directions for a fixed frequency f and frame n.

The distribution p(f,n,d) can be thought of as a probability distribution in that the quantities are all in the range 0.0 to 1.0 and the sum over all the index values is 1.0. Also, it should be understood that the direction distributions p(d|f,n) are not necessarily 0 or 1, and in some implementations may be represented as a distribution with non-zero values for multiple discrete direction values d. In some embodiments, the distribution may be discrete (e.g., using fixed or adaptive direction “bins”) or may be represented as a continuous distribution (e.g., a parameterized distribution) over a one-dimensional or multi-dimensional representation of direction.

Very generally, a number of implementations of the signal separation approach are based on forming an approximation q(f,n,d) of p(f,n,d), where the distribution q(f,n,d) has a hidden multiple-source structure, i.e. a structure that includes multiple sources where little or no information about the sources is known.

Referring to FIG. 10, one approach to representing the hidden multiple source structure is using a non-negative matrix factorization (NMF) approach, and, more generally, a non-negative tensor (i.e., three or more dimensional) factorization (NTF) approach. The signal is assumed to have been generated by a number of distinct sources, indexed by s=1, . . . , S. Each source is also associated with a number of prototype frequency distributions indexed by z=1, . . . , Z. The prototype frequency distributions q(f|z,s) 1110 provide relative magnitudes of various frequency bins, which are indexed by f. The time-varying contributions of the different prototypes for a given source is represented by terms q(n,z|s) 1120, which sum to 1.0 over the time frame index values n and prototype index values z. Absent direction information, the distribution over frequency and frame index for a particular source s can be represented as

$$q ( f , n \vert s ) = {\sum }_{z} q ( f \vert z , s ) q ( n , z \vert s )$$

Direction information in this model is treated, for any particular source, as independent of time and frequency or the magnitude at such times and frequencies. Therefore a distribution q(d|s) 1130, which sums to 1.0 for each s, is used. A relative contribution of each source, q(s) 1140, sum to 1.0 over the sources. In some implementations, the joint quantity q(d,s)=q(d|s)q(s) is used without separating into the two separate terms. Note that in alternative embodiments, other factorizations of the distribution may be used. For example, q(f,n|s)=Σ_{z}q(f,z|s)q(n|z,s) may be used, encoding an equivalent conditional independence relationship.

The overall distribution q(f,n,d) is then determined from the constituent parts as follows:

$$q ( f , n , d ) = {\sum }_{s , z} q ( f , n , d , s , z ) = {\sum }_{s} q ( s ) q ( d \vert s ) ( {\sum }_{z} q ( f \vert z , s ) q ( n , z \vert s ) )$$

In general, operation of the signal separation phase finds the components of the model to best match the distribution determined from the observed signals. This is expressed as an optimization to minimize a distance between the distribution p( ) determined from the actually observed signals, and q( ) formed from the structured components, the distance function being represented as D (p(f,n,d)∥q(f,n,d)). A number of different distance functions may be used. One suitable function is a Kullback-Leibler (KL) divergence, defined as

$${D}_{KL} ( p ( f , n , d ) \vert \vert q ( f , n , d ) ) = {\sum }_{f , n , d} p ( f , n , d ) ln \frac{p ( f , n , d )}{q ( f , n , d )}$$

For the KL distance, a number of alternative iterative approaches can be used to find the best structure of q(f,n,d,s,z). One alternative is to use an Expectation-Maximization procedure (EM), or another example of a Minorization-Maximization (MM) procedure. An implementation of the MM procedure used in at least some embodiments can be summarized as follows:
1) Current estimates (indicated by the superscript 0) are known providing the current estimate:

q⁰(f,n,d,s,z)q⁰(d,s)q⁰(d,s)qₛ⁰(f|z)q⁰(n,z|s)
2) A marginal distribution is computed (at least conceptually) as

$${q}^{0} ( s , z \vert f , n , d ) = {q}^{0} ( f , n , d , s , z ) / {\sum }_{s , z} {q}^{0} ( f , n , d , s , z )$$

3) A new joint distribution is computed as

r(f,t,d,s,z)=p(f,n,d)q⁰(s,z|f,n,d)
4) New estimates of the components (index by the superscript 1) are computed (at least conceptually) as

$${q}^{1} ( d , s ) = {\sum }_{f , n , z} r ( f , n , d , s , z ) , \\ {q}^{1} ( f \vert s , z ) = {\sum }_{n , d} r ( f , n , d , s , z ) / {\sum }_{f , n , d} r ( f , n , d , s , z ) , \\ and$$

$${q}^{1} ( n , z \vert s ) = {\sum }_{f , d} r ( f , n , d , s , z ) / {\sum }_{f , n , d , z} r ( f , n , d , s , z ) .$$

In some implementations, the iteration is repeated a fixed number of times (e.g., 10 times). Alternative stopping criteria may be used, for example, based on the change in the distance function, change in the estimated values, etc. Note that the computations identified above may be implemented efficiently as matrix computations (e.g., using matrix multiplications), and by computing intermediate quantities appropriately.

In some implementations, a sparse representation of p(f,n,d) is used such that these terms are zero if d≠D(f,n). Steps 2-4 of the iterative procedure outlined above can then be expressed as
2) Compute

ρ(f,n)=p(f,n)/q⁰(f,n,D(f,n))
3) New estimates are computed as

$${q}^{1} ( d , s ) = {q}^{0} ( d , s ) {\sum }_{f , n : D ( f , n ) = d} ρ ( f , n ) {q}^{0} ( f , n \vert s ) , \\ {q}^{1} ( f , s , z ) = {q}^{0} ( f \vert s , z ) {\sum }_{n} ρ ( f , n ) {q}^{0} ( D ( f , n ) , s ) {q}^{0} ( n , z \vert s ) ,$$

and
   q¹(n,z|s) is computed similarly.

Once the iteration is completed, the per-source mask function may be set as

$${M}_{s} ( f , n ) = q ( s \vert f , n ) = {\sum }_{d , z} q ( f , n , d , s , z ) / {\sum }_{d , s , z} q ( f , n , d , s , z )$$

In some examples, the index s* of the desired source is determined by the estimated direction q(d|s) for the source (e.g., the desired source is in a desired direction), the relative contribution of the source q(s) (e.g., the desired source has the greatest contribution), or both.

A number of different approaches may be used to separate the desired signal using a mask.

In one approach, a thresholding approach is used, for example, by setting

$$\tilde{X} ( f , n ) = \{ \begin{matrix}X ( f , n ) & if & {M}_{{s}^{*}} ( f , n ) > thresh \\ 0 & otherwise & \end{matrix}$$

In another approach, a “soft” masking is used, for example, scaling the magnitude information by M_{s*}(f,n), or some other monotonic function of the mask, for example, as an element-wise multiplication

X̅(f,n)=X(f,n)M_{s*}(f,n)

This latter approach is somewhat analogous to using a time-varying Wiener filter in the case of X(f,n) representing the spectra energy (e.g., squared magnitude of the STFT).

If should also be understood that yet other ways of separating a desired signal from the acquired signals may be based on the estimated decomposition. For example, rather than identifying a particular desired signal, one or more undesirable signals may be identified and their contribution to X(f,n) “subtracted” to form an enhanced representation of the desired signal.

Furthermore, as introduced above, the mask information may be used in directly estimating spectrally-based speech recognition feature vectors, such as cepstra, using a “missing data” approach (see, e.g., Kuhne et al., “Time-Frequency Masking: Linking Blind Source Separation and Robust Speech Recognition,” in Speech Recognition, Technologies and Applications (2008)). Generally, such approaches treat time-frequency bins in which the source separation approach indicates the desired signal is absent as “missing” in determining the speech recognition feature vectors.

In the discussion above of estimation of the source and direction structured representation of the signal distribution, the estimates may be made independently for different utterances and/or without any prior information. In some embodiments, various sources of information may be used to improve the estimates.

Prior information about the direction of a source may be used. For example, the prior distribution of a speaker relative to a smartphone, or a driver relative to a vehicle-mounted microphone, may be incorporated into the re-estimation of the direction information (e.g., the q(d|s) terms), or by keeping these terms fixed without re-estimation (or with less frequent re-estimation), for example, at being set at prior values. Furthermore, tracking of a hand-held phone's orientation (e.g., using inertial sensors) may be useful in transforming direction information of a speaker relative to a microphone into a form independent of the orientation of the phone. In some implementations, prior information about a desired source's direction may be provided by the user, for example, via a graphical user interface, or may be inherent in the typical use of the user's device, for example, with a speaker being typically in a relatively consistent position relative to the face of a smartphone.

Information about a source's spectral prototypes (i.e., qₛ(f|z)) may be available from a variety of sources. One source may be a set of “standard” speech-like prototypes. Another source may be the prototypes identified in a previous utterance. Information about a source may also be based on characterization of expected interfering signals, for example, wind noise, windshield wiper noise, etc. This prior information may be used in a statistical prior model framework, or may be used as an initialization of the iterative optimization procedures described above.

In some implementations, the server may provide feedback to the client device that aids the separation of the desired signal. For example, the user's device may provide the spectral information X(f,n) to the server, and the server through the speech recognition process may determine appropriate spectral prototypes qₛ(f|z) for the desired source (or for identified interfering speech or non-speech sources) back to the user's device. The user's device may then use these as fixed, as prior estimates, or initializations for iterative re-estimation.

It should be understood that the particular structure for the distribution model, and the procedures for estimation of the components of the model, presented above are not the only approach. Very generally, in addition to non-negative matrix factorization, other approaches such as Independent Components Analysis (ICA) may be used.

In yet another novel approach to forming a mask and/or separation of a desired signal the acquired acoustic signals are processed by computing a time versus frequency distribution P(f,n) based on one or more of the acquired signals, for example, over a time window. The values of this distribution are non-negative, and in this example, the distribution is over a discrete set of frequency values fε[1,F] and time values nε[1,N]. In some implementations, the value of P(f,n₀) is determined using STFT at a discrete frequency f in the vicinity of time t₀ of the input signal corresponding to the n₀^{th} analysis window (frame) for the STFT.

In addition to the spectral information, the processing of the acquired signals may also include determining directional characteristics at each time frame for each of multiple components of the signals. One example of components of the signals across which directional characteristics are computed are separate spectral components, although it should be understood that other decompositions may be used. In this example, direction information is determined for each (f,n) pair, and the direction of arrival estimates on the indices as D(f,n) are determined as discretized (e.g., quantized) values, for example dε[1,D] for D (e.g., 20) discrete (i.e., “binned”) directions of arrival.

For each time frame of the acquired signals, a directional histogram P(d|n) is formed representing the directions from which the different frequency components at time frame n originated from. In this embodiment that uses discretized directions, this direction histogram consists of a number for each of the D directions: for example, the total number of frequency bins in that frame labeled with that direction (i.e., the number of bins f for which D(f,n)=d. Instead of counting the bins corresponding to a direction, one can achieve better performance using the total of the STFT magnitudes of these bins (e.g., P(d|n)∝Σ_{f:D(f,n)=d}P(f|n)), or the squares of these magnitudes, or a similar approach weighting the effect of higher-energy bins more heavily. In other examples, the processing of the acquired signals provides a continuous-valued (or finely quantized) direction estimate D(f,n) or a parametric or non-parametric distribution P(d|f,n), and either a histogram or a continuous distribution P(d|n) is computed from the direction estimates. In the approaches below, the case where P(d|n) forms a histogram (i.e., values for discrete values of d) is described in detail, however it should be understood that the approaches may be adapted to address the continuous case as well.

The resulting directional histogram can be interpreted as a measure of the strength of signal from each direction at each time frame. In addition to variations due to noise, one would expect these histograms to change over time as some sources turn on and off (for example, when a person stops speaking little to no energy would be coming from his general direction, unless there is another noise source behind him, a case we will not treat).

One way to use this information would be to sum or average all these histograms over time (e.g., as P̅(d)=(1/N)ΣₙP(d|n)). Peaks in the resulting aggregated histogram then correspond to sources. These can be detected with a peak-finding algorithm and boundaries between sources can be delineated by for example taking the mid-points between peaks.

Another approach is to consider the collection of all directional histograms over time and analyze which directions tend to increase or decrease in weight together. One way to do this is to compute the sample covariance or correlation matrix of these histograms. The correlation or covariance of the distributions of direction estimates is used to identify separate distributions associated with different sources. One such approach makes use of a covariance of the direction histograms, for example, computed as

Q(d₁,d₂)=(1/N)Σₙ(P(d₁|n)− P̅(d₁))(P(d₂|n)− P̅(d₂))

where P̅(d)=(1/N)ΣₙP(d|n), which can be represented in matrix form as

Q=(1/N)Σₙ(P(n)− P̅)(P(n)− P̅)^{T}

where P(n) and P are D-dimensional column vectors.

A variety of analyses can be performed on the covariance matrix Q or on a correlation matrix. For example, the principal components of Q (i.e., the eigenvectors associated with the largest eigenvalues) may be considered to represent prototypical directional distributions for different sources.

Other methods of detecting such patterns can also be employed to the same end. For example, computing the joint (perhaps weighted) histogram of pairs of directions at a time and several (say 5—there tends to be little change after only 1) frames later, averaged over all time, can achieve a similar result.

Another way of using the correlation or covariance matrix is to form a pairwise “similarity” between pairs of directions d₁ and d₂. We view the covariance matrix as a matrix of similarities between directions, and apply a clustering method such as affinity propagation or k-medoids to group directions which correlate together. The resulting clusters are then taken to correspond to individual sources.

In this way a discrete set of sources in the environment is identified and a directional profile for each is determined. These profiles can be used to reconstruct the sound emitted by each source using the masking method described above. They can also be used to present a user with a graphical illustration of the location of each source relative to the microphone array, allowing for manual selection of which sources to pass and block or visual feedback about which sources are being automatically blocked.

In another embodiment, input mask values over a set of time-frequency locations that are determined by one or more of the approaches described above. These mask values may have local errors or biases. Such errors or biases have the potential result that the output signal constructed from the masked signal has undesirable characteristics, such as audio artifacts.

### Source Separation According to Neural Network (NN) NTF

NN NTF is based on recognition that the NTF method for acoustic source separation described above can be viewed as a composite model in which each acoustic source is modeled via an NMF decomposition and these sources are combined according to an outer model that takes into account direction, itself a form of NMF. By appropriate rearrangement of the update equations, the inner NMF model can be seen as a sort of denoiser: at each iteration the outer model posits a magnitude spectrogram for each source based on previous iterations, the noisy input data, and direction information, and then the inner NMF model attempts to project the posited magnitude spectrogram onto the space of matrices with a fixed nonnegative rank Z and returns to the outer model an iterate approximating this projection.

According to the inner NMF source model, real acoustic sources do not have arbitrary spectra. Instead, the spectrum in each time frame is a non-negative weighted combination of some small number (e.g. Z=50) of prototype spectra. The non-negativity constraint rules out the destructive interference and is mostly justified based on empirical results.

The NMF model is powerful, but also extremely flexible, allowing for the modeling of many speech as well as non-speech noise sources because it incorporates almost no information about the sound. For example it does not enforce any of the temporal continuity or harmonic structure observed in speech.

By replacing the projection onto non-negative rank Z matrices with an operation that models projection onto realistic voice spectra, the structure of speech may be incorporated, improving separation quality. Also, by modeling only one source in the environment in a speech-specific way and modeling the rest of the sources with some other model, e.g. a more generic model such as NMF, the source selection problem of deciding which of the separated sources corresponds to voice is solved automatically.

In the following, NN NTF is described with reference to a sound signal being a voice/speech. However, NN NTF teachings provided herein allow modelling and separating any acoustic sources, not only voice/speech.

Further, some exemplary embodiments described herein refer to Deep NN (DNN). However, teachings provided herein are equally applicable to embodiments where other kinds of NN may be used, such as e.g. recurrent neural nets (RNN) or long short-term memory (LSTM) nets, as well as to embodiments where any other models are applied, e.g. any regression method designed and/or trained to predict or estimate contributions of a particular acoustic source of interest.

First, the basic mode equations of NTF are summarized again, where model may be represented as:

q(f,n,d,z,s):=q(s)q(f|s,z)q(n,z|s)q(d|s)=q(d,s)q(f,z|s)q(n|s,z)

and updates may be represented as:

$$\begin{matrix}{q}^{1} ( d , s ) = {q}^{0} ( d , s ) {\sum }_{f , n} \underbrace{\frac{{p}^{obs} ( f , n , d )}{{q}^{0} ( f , n , d )}}_{call this ρ ( f , n , d )} {q}^{0} ( f , n \vert s ) = {q}^{0} ( d , s ) {\sum }_{f , n} ρ ( f , n , d ) {q}^{0} ( f , n \vert s ) , & ( 1 ) \\ {q}^{1} ( f , z , s ) = {q}^{0} ( f , z \vert s ) {\sum }_{n , d} ρ ( f , n , d ) {q}^{0} ( d , s ) {q}^{0} ( n \vert s , z ) , & ( 2 ) \\ {q}^{1} ( n , z , s ) = {q}^{0} ( n \vert s , z ) {\sum }_{f , d} ρ ( f , n , d ) {q}^{0} ( d , s ) {q}^{0} ( f , z \vert s ) , \\ where \\ {q}^{0} ( f , n , z \vert s ) := {q}^{0} ( f , z \vert s ) {q}^{0} ( n \vert s , z ) & ( 3 )\end{matrix}$$

Update equation (1) is left as is. Then let

π⁰(f,n,s):=Σ_{d}ρ(f,n,d)q⁰(d,s)q⁰(f,n|s)

and note that by substituting the definition of p we can verify that π⁰ is a probability distribution. Then update equations (2) and (3) may be re-written as

$$\begin{matrix}{q}^{1} ( f , z , s ) = {\sum }_{t} \frac{{π}^{0} ( f , n , s )}{{q}^{0} ( f , n \vert s )} {q}^{0} ( f , n , z \vert s ) , & ( 4 ) \\ {q}^{1} ( n , z , s ) = {\sum }_{f} \frac{{π}^{0} ( f , n , s )}{{q}^{0} ( f , n \vert s )} {q}^{0} ( f , n , z \vert s ) . & ( 5 )\end{matrix}$$

Since the right hands of equations (1), (2), and (3) contain q¹(f,z,s) and q¹(n,z,s) through their conditional distribution when conditioned on s, by conditioning equations (4) and (5) on s the following equivalent updates are obtained:

$$\begin{matrix}{q}^{1} ( f , z \vert s ) = {\sum }_{n} \frac{{π}^{0} ( f , n \vert s )}{{q}^{0} ( f , n \vert s )} {q}^{0} ( f , n , z \vert s ) , & ( 6 ) \\ {q}^{1} ( n , z \vert s ) = {\sum }_{f} \frac{{π}^{0} ( f , n \vert s )}{{q}^{0} ( f , n \vert s )} {q}^{0} ( f , n , z \vert s ) . & ( 7 )\end{matrix}$$

For each fixed source s, these are exactly one step of the EM update equations to learn an NMF decomposition π⁰(f,n|s)≈Σ_{z}q(f,z|s)q(n|s,z). The only difference from standard NMF is that the target distribution π⁰(f,n|s) is changing at each iteration of the outer NMF loop.

The following definitions may be provided:

q¹(f,n,z|s):=q¹(f,z|s)q¹(n|s,z)

q¹(f,n|s):=Σ_{z}q¹(f,n,z|s)

So q¹(f,n|s) is an NMF approximation of π⁰(f,n|s) with rank at most Z.

The NMF portion of the updates may then be hidden to obtain:

$$\begin{matrix}{q}^{1} ( d , s ) = {q}^{0} ( d , s ) {\sum }_{f , n} ρ ( f , n , d ) {q}^{0} ( f , n \vert s ) , & ( 8 ) \\ {π}^{0} ( f , n , s ) = {\sum }_{d} ρ ( f , n , d ) {q}^{0} ( d , s ) {q}^{0} ( f , n \vert s ) & ( 9 ) \\ {q}^{1} ( f , n \vert s ) = {Projection}_{NMF [ Z ]} \{ {π}^{0} ( f , n \vert s ) \} for each source s . & ( 10 )\end{matrix}$$

Equations (8)-(10) do not contain q(f,z|s) and q(n|s,z) as these terms are now hidden in the projection step, and in particular a warm start approach to the projection step. Experimental results show that the algorithm computes a result of equal quality, albeit more slowly, if instead of running one iteration of the NMF updates from a warm start within each outer NTF iteration, one starts with random initial conditions and runs the NMF updates until convergence within each NTF iteration.

Now suppose that instead of the NTF model, a model of the following form is fitted:

$${p}^{obs} ( f , n , d ) \approx {\sum }_{s} q ( d , s ) q ( f , n \vert s ) . \qquad ( 11 )$$

This is referred to as Directional NMF because it can be viewed as a plain NMF decomposition of an D×FN matrix into a D×S matrix times an S×FN matrix. This is a decomposition which does not enforce any structure on the magnitude spectrograms of the sources. In fact, the EM updates reduce exactly to (8)-(10) but with the projection replaced by the identify transformation

q¹(f,n|s)=π⁰(f,n|s).

Instead of the identity or projection onto the space of matrices with an NMF decomposition of a particular rank, it is possible to apply any other sort of denoising operation to produce q¹(f,n|s) from π⁰(f,n|s), including different operations for different sources s. For example, a DNN may be trained to transform speech with background noise into clean speech, or speech with the kind of artifacts typical of NTF into clean speech, or some combination of these, and use this DNN in place of the projection in (10).

There are many classes of neural nets that could be trained for this purpose, depending on the desired complexity and what kind of structure is of interest (i.e. which kind of audio signal is to be separated). For example, each time frame of the output could be predicted based on the corresponding time frame of the input, or based on a window of the input. Alternatively or additionally, in order to capture longer range interactions, other types of neural net models may be learned, such as recurrent neural nets (RNN) or long short-term memory (LSTM) nets. Further, nets may be trained to be specific to a single speaker or language, or more general, depending on the training data chosen. All these nets could be integrated into a directional source separation algorithm by the procedure discussed above.

Similar techniques may be applied to learn a model for background noise, e.g. application-specific background noise such as e.g. noises in and around a car, or an NMF model or the trivial Directional NMF model may be used for background source(s).

One feature of the NMF updates is that they converge to a fixed point: repeatedly applying them eventually leads to little or no change and the result is typically a good approximation of the matrix which was to be factored. Neural nets need not have this property, so it may be helpful to structure the training data to induce this idempotence. For example, some training examples may be provided that have clean speech as the input and target.

In an embodiment, a neural net may be softened by taking a step from the input in the direction of the output, e.g. by taking

q¹(f,n|s)=απ(f,n|s)+(1−α)DNN{π(f,n|s)}

for some a close to one.

### Basic NTF Vs NN NTF

As described above, basic NTF is based on using some side information such as e.g. direction information in order to perform source separation. This stems from the fact that generic NMF source model is too unstructured and, therefore, other cues, such as e.g. direction cues, are needed to suggest which spectral prototypes to group together into sources. In contrast to basic NTF, NN NTF approach does not have to use direction data to perform source separation because the NN source model has enough structure to group time-frequency bins into a speech-like source (or any other acoustic source modeled by NN NTF) based on its training data. However, when direction data is available, using it will typically improve separation quality and may reduce convergence time.

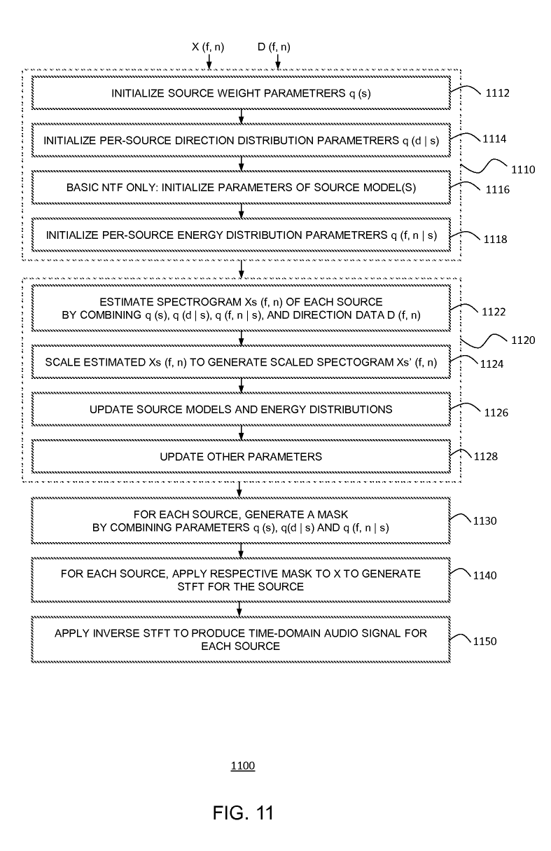

FIG. 11 is a diagram illustrating a flow chart 1100 of method steps leading to separation of acoustic sources using direction data, according to various embodiments of the present disclosure. In particular, FIG. 11 summarizes steps of basic NTF and NN NTF approaches described above for performing signal separation, e.g. as a part of step 930 of the method illustrated in FIG. 9, using direction data D(f,n). While FIG. 11 puts forward steps which could be performed in both basic NTF and NN NTF approaches, discussion below also highlights the differences between the two.

The steps of the flow chart 1100 may be performed by one or more processors, such as e.g. processors or processing units within client devices 810 and 1302 and/or processors or processing units within servers 850 and 1304 described herein. However, any system configured to perform the methods steps illustrated in FIG. 11 is within the scope of the present disclosure. Furthermore, although the elements are shown in a particular order, it will be understood that particular processing steps may be performed by different computing devices in parallel or in a different order than that shown in the FIGURE.

One goal of the flow chart 1100 is to separate an audio mixture into component sources through the use of side information such as one or more models of different acoustic sources (e.g. it may be desirable to separate a particular voice from the rest of audio signals) and direction information described above. To that end, the method 1100 may need to have access to one or more of the following: number of acoustic sources, model type for each acoustic source, hyper parameters for source models, e.g. number of z values or prototypes to use in the NMF case, which denoiser to use in the NN case, microphone array geometry, and hyper parameters for directionality, e.g. whether and/or how to discretize directions, parametric form of allowed direction distributions.

Prior to the method 1100, magnitude data X(f,n) and direction data D(f,n) is collected, e.g. in one of the manners described above with reference to step 920.

In addition, NN NTF approach is based on training an NN source model for one or more acoustic sources that the method 1100 is intended to identify. This training step (not shown in FIG. 11) is also typically done prior to running of the method 1100 because it is time-consuming, computationally-intensive, and may only be performed once and the results may then be re-used each time the method 1100 is run. The NN training step is described in greater detail below in order to compare and contrast it to the source model initialization step of the basic NTF.

The source separation method 1100 may begin with an initialization stage 1110. Stage 1110 may include several initialization steps, at least some of which may occur in any order (i.e. sequentially) or in an overlapping order (i.e. completely or partially at the same time). Typically, such an initialization is done randomly, however, initialization in any manner as known to people skilled in the art is within the scope of the present application. As part of the initialization, in step 1112, source weight parameters q(s) are initialized, where relative total energies are assigned to each one of the sources, thereby indicating contribution of each source in relation to other sources. In step 1114, per-source direction distribution parameters q(d|s) are assigned to each source, for all sources s and directions d.

Steps 1112 and 1114 are equally applicable to both basic NTF and NN NTF approaches. The approaches begin to differ in step 1116, where, applicable to basic NTF only, one or more source models to be used in the rest of the method are initialized. Logically speaking, the step of initializing the source models in basic NTF is comparable to the step of training the NN source models in NN NTF, in that, as a result of performing this step, a model for a particular acoustic source is set up. In practice, however, there are significant differences, some of which are described below.

For basic NTF, the step of initializing source model(s) parameters is typically performed each time source separation process 1100 begins. The step is based on recognition that, for each acoustic source that might be expected in a particular environment, a type of a “source model” may be chosen, depending on what the source is intended to model (e.g. two acoustic sources may be expected: one—voice and one—background noise). As described above for basic NTF, each acoustic source has an NMF source model, which model is quite generic, but nevertheless more restrictive than assuming that the source can produce any spectrogram. Parameters of such an NMF source model (for each source) that are initialized in step 1116 include e.g. a prototype frequency distribution q(f|s,z) and time activations q (n,z|s) which indicate when the prototypes are active.

The basic version of an NN source model has no such parameters. It is intended that the method 1100 for NN NTF would use an NN source model trained to a particular type of acoustic source, e.g. voice, to separate that acoustic source from the mixture.

Training an NN source model, also referred to as “training a denoiser,” refers to training a model to predict a spectrogram (i.e. time-frequency energy distribution, typically magnitude of an STFT) of a particular acoustic source (e.g. speech) from a spectrogram of a mixture of speech and noise. A variety of models (e.g. DNN, RNN, etc.) could be trained by a variety of means, all of which are within the scope of the present disclosure. Such training approaches typically depend on providing a lot of corresponding pairs of clean and noisy data, as known to people skilled in the art and, therefore, not described here.

The type of noise which the denoiser is trained to remove/keep may be chosen freely, depending on a particular implementation of the source separation algorithm. For example, a particular implementation may expect specific types of background noise and, therefore, mixtures with these types of noise may be used as training examples. In another example, when a particular implementation intends to separate speech from other noises, training may further be focused on various aspects such as e.g. speech from a wide variety of speakers, a single speaker, a specific category (e.g. American-accented English speech), etc. depending on the intended application. One could similarly train an NN model to predict background noise from a mixture of speech and noise and use this as an NN background noise model.

In context of NN NTF, step 1116 may be comparable to training of an NN model to predict a particular acoustic source from a mixture of sounds. Unlike step 1116 that is performed every time the separation method 1100 is run, the NN model training may be performed once and then re-used every time the separation method is run. This difference arises from the fact that training an NN model typically takes an enormous amount of training data and computational resources, e.g. the order of terabytes and weeks on a cluster and/or CPU. The result is then a trained network which may be viewed as a distilled version of the training data taking up e.g. on the order of maybe megabytes (for embedded systems, the amount of data in an NN model is limited by the size of the embedded memory, in cloud-based system, the amount of data may be larger). Typically, the NN training is performed well in advance, on a system that is much more powerful than that needed for running the separation method itself, and then the learned NN coefficients are encoded onto a memory of the system that will be running the separation method, to be loaded from the memory at run time. The basic NTF source model (NMF source model), on the other hand, is initialized randomly at run time, which amounts to generating perhaps on the order of 8e4 to 8e6 random numbers and is quite fast.

In an embodiment, the method 1100 may use a combination of one or more NN source models and one or more basic NMF source models, e.g. by using an NN source model to capture the acoustic source for which the model is trained (e.g. voice) and to use another source model, such as e.g. NMF, to capture everything else (e.g. background noise).

The method may then proceed to step 1118, where the source models are used to initialize per-source energy distribution q(f,n|s). This is also where the basic NTF and NN NTF approaches differ. In the case of basic NTF, this step involves assigning per-source energy distribution

$$q ( f , n \vert s ) = {\sum }_{z} q ( f \vert z , s ) q ( n , z \vert s )$$

as described above. In case of NN NTF, per-source energy distribution of an NN source model could be initialized randomly or by some other scheme, such as e.g. running the NN on X (i.e. the collected magnitude data).

The method may then proceed to the iteration stage 1120, which stage comprises steps 1122-428.

In step 1122 of the iteration stage 1120, parameters q(s), q(d|s), per source energy distributions q(f,n|s), and direction data D(f,n) are combined to estimate spectrogram Xs(f,n) of each source. Typically, such a spectrogram will be very wrong in early iterations but will converge to a sensible spectrogram later on.

In step 1124 of the iteration stage 1120, for each time-frequency bin, the estimated spectra Xs (f,n) are scaled so that the sum over all sources adds up to X(f,n). The scaling is done per bin. The result may be referred to as Xs′(f,n). Steps 1122 and 1124 are performed substantially the same for both, basic NTF and NN NTF, approaches.

In step 1126 of the iteration stage 1120, source models and energy distributions are updated based on the scaled estimated spectra of step 1124. This is where the basic NTF and NN NTF differ again. In case of a NMF source model (i.e. basic NTF), step 1126 involves updating the source model parameters and then re-computing q(f,n|s) as done in step 1118. In case of an NN model, step 1126 involves running the NN model (or whichever other model may be used) with input Xs′(f,n) and referring to the output as “q(f,n|s).”

In step 1128 of the iteration stage 1120, which, again, may be performed substantially the same for both, basic NTF and NN NTF, approaches, other model parameters may be updated. To that end, e.g. q(s) may be updated to reflect relative total energy in the different acoustic sources and q(d|s) may be updated to be the weighted histogram given by weighting the directions D(f,n) according to weights Xs′(f,n). In some embodiments, q(d|s) may then be modified to remain within a preselected parametric family, thereby sharing some statistical strength between different parts of the model and avoiding over fitting.

Steps 1122-428 of the iteration stage 1120 are iterated for a number of times, e.g. for a certain number of iterations (either predefined or dynamically defined), until one or more predefined convergence conditions is(are) satisfied, or until a command is received indicating that the iterations are to be stopped (e.g. as a result of receiving user input to that effect).

Once the iterations are finished, the method may then proceed to stage 1130 where values of the model parameters q(s), q(d|s), and q(f,n|s) available after the iteration stage 1120 are used to generate, for each source of interest, a respective mask for identifying contributions from the source to the characteristics X. In an embodiment, such a mask may be generated by carrying out steps similar to steps 1122 and 1124, but optionally without incorporating the direction portions, to produce estimated separated spectra. One reason for leaving out direction data in stage 1130 may be to limit the use of directional cues to learning the rest of the model, in particular steps of the iteration stage 1120, without overemphasizing the noisy directional data in the final output of the method 1100. The outputs of the iteration stage 1120, i.e. parameters q(s), direction distribution q(d|s), and per-source energy distributions q(f,n|s), are provided as an input to step 1130, where these outputs are combined to estimate a new spectrogram Xs(f,n) of each source. Then, for each time-frequency bin, the fraction Mₛ(f,n)=Xₛ(f,n)/ΣₛXₛ(f,n) of mass in the bin due to each source is computed, similar to how a mask per source is described above.

For each source s, the quantities Mₛ(f,n) may be viewed as soft masks because their value in each time-frequency bin is a number between zero and one, inclusive. In other implementations, one may modify the mask, such as by applying a threshold to it to produce a hard mask, which only takes values zero and one, and typically has the effect of increasing perceived separation but may also cause artifacts. In some embodiments, masks may be modified by other nonlinearities. In some embodiments, the values of a soft or a hard mask may be softened by reducing their range from [0,1] to some smaller subset, e.g. [0.1, 0.9], to have the effect of decreasing artifacts at the expense of decreased perceived separation.

The method may then proceed to step 1140 where an estimated STFT is generated for each source by applying a mask for the source to the time-dependent spectral characteristics. In one embodiment, step 1140 may be implemented by multiplying the mask Mₛ(f,n) by the STFT of the noisy signal to get the estimated STFT for the sources.

In step 1150, inverse STFT may be applied to the outcome of step 1140 to produce time-domain audio for each source (or for a desired subset thereof).

Similar to steps 1112, 1114, 1122, 1124, and 1128, steps 1130, 1140, and 1150 may be performed substantially the same for both, basic NTF and NN NTF, approaches.

As the foregoing description illustrates, differences between basic NTF and NN NTF model reside in steps 1116, 1118, and 1126. In the basic NTF case, when all sources have NMF source models, the method is symmetric with respect to sources. The symmetry is broken by the random initialization, but one still does not know which separated source corresponds to e.g. voice vs. background noise. In the NN source model case, the expectation is that e.g. a model trained to isolate voice will end up corresponding to a voice source, since it is being nudged in that direction at each iteration, while the other source will end up modeling background noise. Therefore, the NN source model solves not only the source separation but also the source selection problem—selecting which separated source is the desired one (the voice, in most applications). In an embodiment, computational resources may be saved by only computing the inverse STFT of the desired source (e.g. voice) and passing only the resulting single audio stream on as the output of the method 1100.

Incorporating a model of an acoustic source that is data-driven, such as an NN model, rather than a generic model not specific to any acoustic source, such as an NMF model, may improve quality of the separation by e.g. decreasing the amount of background which remains in the voice source after separation and vice versa. Furthermore, it enables source separation without using direction data. To that end, steps of FIG. 11 described above for the NN NTF approach may be repeated without the use of directional data mention therein. In the interests of brevity, steps omitting the direction data are not repeated here.

Combination of Basic NTF with NN Source Model(s)

As described above, basic NTF may be combined with using one or more NN source models by e.g. using an NN source model to capture the acoustic source for which the model is trained (e.g. voice) and to use the NMF source model of basic NTF to capture everything else (e.g. background noise).

Another way to benefit from the use of NN model(s) is by applying the NN model(s) to the input magnitude data X. Such an implementation, referred to herein as an “NTF with NN redux,” is described below for the example of using an NN model that is trained to recognize voice from a mixture of acoustic signals. The term “redux” is used to express that such an implementation benefits, in a reduced form (hence, “redux”) from the incorporation of an additional model such as an NN source model.

Source Separation According to Basic NTF with NN Redux

The basic NTF algorithm described above is based on using a, typically discretized, direction estimate D(f,n) for each time-frequency bin, where the estimates are used to try to group energy coming from a single direction together into a single source, and, if the parametric family technique mentioned in step 1128 above is used, to a lesser extent group energy from close directions into a single source. The NTF with NN redux approach is based on an insight that an NN model, or any other model based on regression or classification analysis, may be used to analyze the input X(f,n) and provide cues G(f,n) which are value(s) of a multi-valued property representing value(s) of the property the mass in that bin represents, e.g. which type of source the mass in the bin is believed to correspond to, such as e.g. a particular voice. These cues can be used in the same way as the directionality cues to try to group together time-frequency bins which are likely to contain contributions sharing the same property and conclude that these bins comprise contributions generated by a single source of interest (e.g. voice). Time-frequency bins which are not likely to contain such contributions may be grouped together into another source (e.g. everything else besides the voice). Thus, the NTF with NN redux method may proceed in the same manner as the basic NTF described above, in particular it would use the NMF source models as described above, except that everywhere where direction terms D(f,n) and q(d|s) are used, corresponding contributions from G(f,n) and a new term q(g|s) would be used in place of the direction terms.

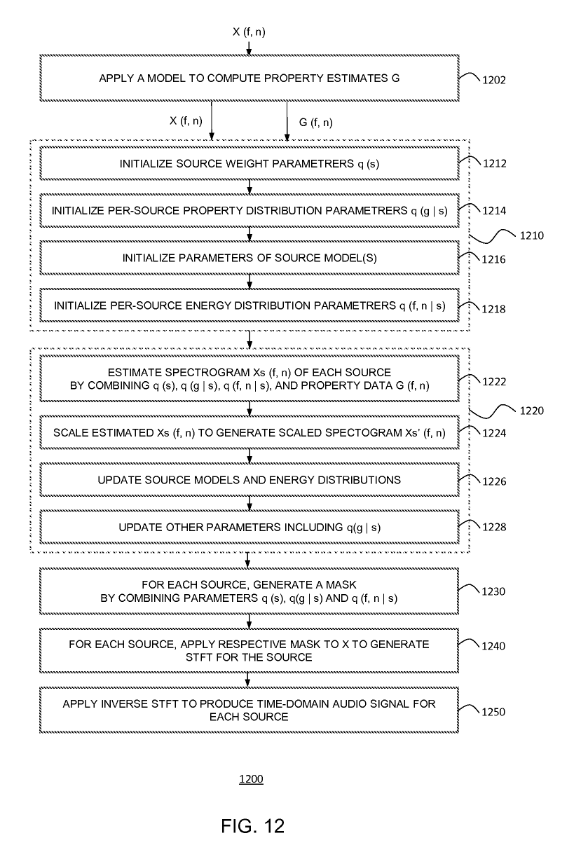

FIG. 12 is a diagram illustrating a flow chart 1200 of method steps leading to separation of acoustic sources using property estimates G, according to an embodiment of the present disclosure. In particular, FIG. 12 summarizes steps of a basic NTF approach described above for performing signal separation, e.g. as a part of step 930 of the method illustrated in FIG. 9, using property estimates G(f,n).

The steps of the flow chart 1200 may be performed by one or more processors, such as e.g. processors or processing units within client devices 810 and 1302 and/or processors or processing units within servers 850 and 1304 described herein. However, any system configured to perform the methods steps illustrated in FIG. 12 is within the scope of the present disclosure. Furthermore, although the elements are shown in a particular order, it will be understood that particular processing steps may be performed by different computing devices in parallel or in a different order than that shown in the FIGURE.

Similar to the method 1100, one goal of the flow chart 1200 is to separate an acoustic mixture into component sources through the use of side information. To that end, similar to the method 1100, the method 1200 may need to have access to one or more of the following: number of acoustic sources, model type for each acoustic source, hyper parameters for source models, e.g. number of z values or prototypes to use in the NMF case, which denoiser to use in the NN case, microphone array geometry, and hyper parameters for directionality, e.g. whether and/or how to discretize directions, parametric form of allowed direction distributions.

Prior to the method 1200, magnitude data X(f,n) is collected, e.g. in one of the manners described above with reference to step 920.

In addition, NTF with NN redux approach is based on using a model, such as e.g. an NN model, trained and/or designed to compute property estimates G of a predefined property for the spectral characteristics X. Such training may be done prior to running the method 1200, and the resulting models may then be re-used in multiple instances of running the source separation algorithm of FIG. 12. Discussions provided for an NN model with reference to FIG. 11 are applicable here and, therefore, in the interests of brevity, are not repeated.

The source separation method 1600 may begin with step 1202 where magnitude data X(f,n) is provided as an input to a model, such as e.g. a NN model. The model is configured to compute property estimates G of a predefined property, so that each time-frequency bin being considered (some may be not considered because they are e.g. too noisy) is assigned one or more property estimates of the predefined property so that the one or more property estimates correspond to the mass in the bin. In other words, each time-frequency bin being considered would have a corresponding one or more likelihood estimates, where likelihood estimate indicates how likely it is that the mass X(fin) in that bin corresponds to a certain value of the property. For example, if the property is “direction,” the value could be e.g. “north by northeast”, “southwest”, or “perpendicular the plane of the microphone array.” In another example, if the property is “speech-like,” then the value could be e.g. “yes”, “no”, “probably.” In yet another example, if the property is something more specific like a “type of speech,” then the values could be “male speech”, “female speech”, “not speech”, “alto singing”, etc. Any variations and approaches for quantizing the possible values of a property estimate are within the scope of the present disclosure.

As a result of applying the model in step 1202, property estimates G(f,n) may be provided to the NTF model, as shown with G(f,n) being provided from step 1202 to an initialization stage 1210. In addition, the magnitude data X is provided as well (as also shown in FIG. 12).

The initialization stage 1210 is similar to the initialization stage 1110 for the basic NTF except that property estimates are used in place of direction estimates. Discussions provided above for steps 1112, 1116 and 1118 for the NTF model are applicable to steps 1212, 1216, and 1218, and therefore, are not repeated here. In step 1214, per-source property distribution parameters q(g|s) are assigned to each source, for all sources s and property estimates G.

After the initialization stage 1210, the method 1200 may then proceed to the iteration stage 1220, which stage comprises steps 1222-1228.

In step 1222 of the iteration stage 1220, parameters q(s), q(g|s), per source energy distributions q(f,n|s), and property estimates G(f,n) are combined to estimate spectrogram Xs(f,n) of each source. Typically, such a spectrogram will be very wrong in early iterations but will converge to a sensible spectrogram later on.

Steps 1224, 1228, 1230, 1240, and 1250 are analogous to steps 1124, 1128, 1130, 1140, and 1150 described above for the basic NTF except that instead of direction distribution q(d|s) property distribution q(g|s) is used, and, in the interests of brevity, are not repeated here.

In comparison with the basic NTF, the NTF with NN redux approach may provide increased separation quality. Furthermore, despite the fact that generic NMF models may be used for source separation, the NTF with NN redux approach solves the source selection problem because the final iterates of the term q(g|s) provide information about which source is the source of interest (e.g. which source is voice). It may also be considered to be advantageous to the NN NTF approach described above because the NN only needs to be run once (in step 1202), as opposed to doing it in each iteration (in step 1126), thus reducing demands on computational and memory resources of a system running the method.

Source Separation According to NN NTF with NN Redux

Not only the basic NTF approach described above, but also the NN NTF approach described above may benefit from applying the NN redux as described above for the basic NTF. Such an approach is referred to herein as “NN NTF with NN redux” indicating that it is a combination of the NN NTF approach with the NN redux approach described herein. Similar to basic NTF with NN redux, the NN NTF with NN redux is also based on an insight that an NN model, or any other model based on regression analysis, may be used to analyze the input X(f,n) and provide cues G(f,n) which are value(s) of a multi-valued property representing value(s) of the property the mass in that bin represents, e.g. which type of source the mass in the bin is believed to correspond to, such as e.g. a particular voice. The manner in which such cues are used and incorporated into an NTF model is similar to the one described above with reference to FIG. 12, except that this time the NTF model is the NN NTF model as described above. Therefore, in the interests of brevity, these discussions are not repeated here.

It should be noted that in an NN NTF with NN redux approach an NN model is used in two contexts. One time an NN model is used in a step where the magnitude data X is provided as an input to such a model that is then configured to compute property estimates G of a predefined property for the different bins of data X (in a step analogous to step 1202 described above). Another time an NN model is used as a part of performing the iterations of the NTF model, where the iterations include running the NN model to separate contributions of an acoustic source of interest from the audio mixture. In some embodiments, these two models may be the same model, e.g. a model configured to identify a particular voice. However, in other embodiments, these two models may be different.

### Streaming NTF

Large amounts of data acquired by an array of one or more acoustic sensors create additional challenges to performing source separation because running the models on large amounts of data requires large computational and memory resources and may be very time consuming. These challenges become especially pronounced in implementations where sensor data changes quickly.

An aspect of the present disclosure that aims to reduce or eliminate the problems associated with processing quickly changing large sets of data is based on an insight that running a full analysis each time sensor data changes is at best inefficient, and more likely impossible. Such an aspect of the present disclosure offers a method, referred to herein as a “streaming NTF” method, enabling one or more processing units to identify and process incremental changes to an NTF model rather than re-processing the entire model. Such incremental stream processing provides an efficient and fast manner for performing source separation on quickly changing data.

The streaming NTF method described herein is applicable to any models for source separation such as e.g. NMF model as known in the art or any of the approaches described herein, such as the basic NTF, NN NTF, basic NTF with NN redux and NN NTF with NN redux and any combinations of these approaches. Moreover, while the streaming NTF method is described herein with reference to source separation of a particular acoustic source of interest from a mixture of audio signals, the method is equally applicable to doing source separation on other signals, such as e.g. electromagnetic signals, as long as an NTF or NMF model is used. For example, one application of the streaming NTF method described herein could be in tracking heart rate from photo-sensors on a person's wrist in the presence of motion artifacts. More generally, applications include any source separation tasks in which a structured signal of interest is corrupted by one or more structured interferers.

First, a theoretical framework for the streaming NTF approach is described, illustrating how batch mode NTF (i.e. NTF that requires its full input over all time to begin processing) may be adapted to a streaming version. Such a streaming NTF may offer flexible latency/quality tradeoffs and fixed memory requirements independent of stream length.

The basic mode equations of NTF summarized above (model and updates in formulas (1)-(3)) are applicable here and, in the interest of brevity are not repeated.

To modify the batch mode updates to produce a streaming mode version, first, the sums over all time in equations (1) and (2) are reinterpreted as sums over time up to the present time frame: n≦N₁. Since q¹(n,z,s) is only updated for time up to the present, equation (3) is evaluated for n≦N₁ as well.

The resulting updates may be run for as many iterations as desired and incorporate new data as time passes by incrementing N₁, initializing q(n=N₁|s,z) based on how much new energy is in the input spectrogram at n=N₁ relative to n≦N₁, and iterating the equations some more. The problem with this approach is that the full past p(f,n,d) and q0(n|s,z) must be stored to run each iteration, so as more data streams in, the iterations would take proportionally more time and memory. Embodiments of the present disclosure are based on recognition that such an approach would update the time activation factor q¹(n,z,s) over the entire past n≦N₁ at every iteration, but in a streaming source separation application with bounded latency, decisions made before some N₀<N₁ would be fixed and the separated data would already have been output so in a sense revisiting these decisions would be a waste of computational effort.

Therefore, according to the streaming NTF approach, some N₀<N₁ is fixed and N₀≦n≦N₁ is viewed as the present block is being operated on. Then q¹(n,z,s) is only updated for the present block, which means that the update (3) may be run only knowing p(f,n,d) for the present block. On the other hand, updates (1) and (2) both still have sums over the entire past. To address this, an approximation can be made where the portions of these sums (including the factor in front of the sum) over n<N₀ are stored in memory and these terms are not updated on each iteration as they technically should be. In this manner, streaming updates are obtained:

$${q}^{1} ( d , s ) = {q}^{old} ( d , s ) + {q}^{0} ( d , s ) {\sum }_{{N}_{0} \leq n \leq {N}_{1} , f} ρ ( f , n , d ) {q}^{0} ( f , n \vert s ) , \\ {q}^{1} ( f , z , s ) = {q}^{old} ( f , z , s ) + {q}^{0} ( f , z \vert s ) {\sum }_{{N}_{0} \leq n \leq {N}_{1} , d} ρ ( f , n , d ) {q}^{0} ( d , s ) {q}^{0} ( n \vert s , z ) , {q}^{1} ( n , z , s ) = {q}^{0} ( n \vert s , z ) {\sum }_{f , d} ρ ( f , n , d ) {q}^{0} ( d , s ) {q}^{0} ( f , z \vert s ) for {N}_{0} \leq n \leq {N}_{1} .$$

In order to properly weight the past against the present block, the invariant that all p's and q's are normalized to be probability distributions is no longer maintained. Instead, X may be computed as in batch mode (e.g. as a noisy magnitude spectrogram weighted by direction estimates) and may be left un-normalized. The invariant that distributions q^{old} sum to whatever value X sums to when all variables are summed out but n is only summed over the past n<N₀ is maintained. The sum of the present terms in each of the first two equations for streaming updates above is then equal to the sum of X with n only summed over the present block. Thus the present and past are weighted against each other in the streaming updates as they are in the input. All the q distributions updated on each iteration may be viewed as implicitly restricted to or, by normalizing, conditioned on N₀≦n≦N₁.

When the streaming updates have run for as many iterations as desired on the present block, the current factorization can be used to compute a time-frequency mask at one time frame (e.g. n=N₀, n=N₁, or an intermediate value depending on the desired latency-accuracy tradeoff) and then this mask may be used to scale the corresponding portion of the noisy input STFT. Applying the inverse FFT to this masked frame and optionally multiplying by a window function yields a frame worth of separated time-domain signal. Since the forward STFT is computed by breaking the time-domain signal into overlapping chunks, the inverse STFT must add together corresponding overlapping chunks. Therefore the frame worth of separated time domain signal is shifted appropriately relative to a buffer of corresponding results from previous stages and added to these. The portion of the buffer for which all relevant STFT frames have been processed is now ready to be streamed out. The remainder of the buffer is saved awaiting more separated frames to add to it.

To continue, the present window may then be shifted by incrementing N₀ and N₁ when a new time frame of input data X is obtained. To maintain the invariants discussed above, the following increment are made:

q^{old}(d,s)+=q⁰(d,s)ρ(f,N₀,d)q⁰(f,N₀|s),

q^{old}(f,z,s)+=q⁰(f,z|s)ρ(f,N₀,d)q⁰(d,s)q⁰(N₀|s,z).

Also, various embodiments of the streaming NTF method may be technically free to reinitialize the q distributions (except q^{old}), but in the interest of saving work and decreasing the number of iterations required on each block, some embodiments may choose to minimize the re-initialization. To do this, in an embodiment, q(d,s) and q(f,z|s) may be kept from the previous block. Alternatively, to avoid local optima, these values may be softened slightly by e.g. averaging with a uniform distribution. For q(n|s,z), one solution could be to remove the n=N₀ portion, and add in a flat n=N₁+1 portion, scaling this against q(n|s,z) for the retained frames N₀+1≦n≦N₁ according to the mass in X in those retained frames vs. the mass at n=N₁+1.

One advantage of the streaming mode version over the batch mode version is that it admits a natural modification to allow it to gradually forget the past and adapt to changing circumstances (e.g. moving sound sources or microphones or changing acoustic environment). All that is needed is to multiply the previous value of q^{old} (in the two equations for q^{old} above) by some discount factor less than 1, e.g. 0.9, before adding the increment term.

To summarize, a streaming mode version of the basic NTF method is described above. The streaming version operates on a moving block of time frames of fixed length N₁−N₀. In various embodiments, several free parameters may influence the performance of the streaming version. For example, the size of the block can be adjusted to trade off accuracy (in the sense of fidelity to the block mode version) with computational burden per iteration, the position within the block at which values are used to compute masks for separation can be adjusted to trade off accuracy with latency, and a discount factor can be adjusted to trade off accuracy with adaptation to changing circumstances.

The streaming mode version of the basic NTF method described above is one particular implementation. From this description a person skilled in the art will realize how to modify the description to produce implementations with e.g. blocks of varying size, blocks which advance multiple frames simultaneously, and blocks which produce multiple frames of output. Such implementations are within the scope of the present application.

Now, a textual outline for the streaming NTF method is presented.

The streaming NTF method is based on maintaining (for processing) a finite block of the recent past, while the distant past is only retained through some summary statistics. This mode of operation has never been used for an NMF/NTF-like algorithm as these algorithms are typically operated in batch mode.

In the streaming NTF method, rather than having a sequence of steps, information is streaming through different interacting blocks, which may in turn be implemented as a series of steps on e.g. one or more processing units, e.g. DSP.

In setting hyperparameters, in various embodiments, either the system carrying out the streaming NTF method or a user is free to decide on a block size for the sliding block, e.g. 10 frames of audio, with the idea that some portion of data (e.g. 10 frames of audio) is maintained, a new portion of data is periodically received, and the oldest portion is eventually removed/deleted. The system or a user is also free to decide on what time frame(s) relative to the block will be used to generate masks for separation. Frames farther in the future correspond to lower latency, while frames further in the past correspond to more iterations, more data incorporated, and a closer match to the batch version.

In an embodiment, an initialization stage of streaming NTF may include steps similar to those described for the stage 1110 with reference to FIG. 11 as well as a few extra steps. In comparison with the steps of stage 1110, similar initialization steps in context of streaming NTF are modified so that any parameters like q(n|s,z), whose size is the number of time frames of the acquired signal, are now sized to the number of frames in chosen block size. Extra steps include defining a q^{old}(d,s) and q^{old}(f,z,s) in a manner similar to the corresponding q's but which will keep track of the summary of the distant past; these may be initialized to all zeros or to some nonzero values with the effect of biasing the streaming factorization toward the given values. If grouping cues as described in the NN redux method(s) are used, then there will also be a q^{old}(g,s), used substantially the same way as the direction data. If there is an NN source model then there are no z's and so no q^{old}(f,z,s), but the method may still need to track some past state of the NN. For example, if the NN model used is an RNN/LSTM, then one would keep the most recent value of its internal state variables before the current block.

Running the streaming NTF method involves running the iterations of steps similar to those described for stage 1120, with slight modifications, for some (e.g. predetermined) number of iterations, then computing a mask for the time frame(s) corresponding to the portion of the block chosen in the hyperparameter selection phase. In an embodiment, the mask is computed in a manner similar to that described in step 1130, and then steps analogous to steps 1140 and 1150 are implemented to produce the corresponding portion of separated sound. Then the block will advance and the process continues.

Steps of the streaming NTF method are now described in greater detail. In other embodiments, these steps may be performed in different order.

In step (1), streaming versions of X(f,n) and D(f,n) are computed as in the batch version (the definitions provide a natural streaming method to compute X and D), but now each time frame of these quantities is passed into the source separation step as the time frame becomes available. When the method is started, a number of time frames equal to the block size needs to be accumulated before later steps can continue.

Step (2) could be referred to as the main iteration loop where steps (a) and (b) are iterated. In step (a), steps 1122 and 1124 happen as in batch mode, but applied to the current block. In step (b), steps 1126 and 1128 happen in a slightly modified version as specified in the three streaming updates equations provided above. The last two of these three equations describe the streaming version of the NMF source model, in which the difference is the added q^{old} terms. If an NN source model is used, these updates would change to the corresponding description for FIG. 11 about running the current source estimate through the NN, just as in the batch case for the NN NTF but only on the current block. In cases where the NN model keeps history (e.g. RNN or LSTM), the analog of the q^{old} terms would be to run the NN model with the appropriate initial state.

In step (3), masks for each source of interest are computed. This may be done similar to step 1130 described above, except only performed for the frame(s) of the block chosen when hyperparameters were set up.

In step (4), masks for each source of interest are applied and in step (5) the inverse STFT is applied to output the separated time domain audio signals. These steps are performed similar to steps 1140 and 1150 described above, but, again, only performed on the frame(s) chosen when hyperparameters were set up. One difference here is that the forward STFT is computed by applying the FFT to the overlapping blocks, so the inverse STFT is computed by applying the inverse FFT to the frames and then adding the resulting blocks in an overlapping fashion. Such “overlap and add” (OLA) methods are known to people skilled in the art and, therefore, are not described in detail. However, this becomes slightly subtle in the streaming case because in some implementations it is better to buffer some of the time domain audio instead directly outputting it, so at future steps overlapping blocks from other frames can be added to it. In an embodiment, only after all the blocks which must overlap to produce a particular time sample have been processed is that time sample actually streamed out.

In step (6), history of the NTF processing may be updated. Preferably, in an embodiment, this step is executed before going back to step (1) to stream more data through. In this step, the q^{old} values may be updated in accordance with the two equations for q^{old} described above, then the oldest time frame in the block may be discarded to make room for the new one computed in step (1). The second equation for q^{old} provided above applies specifically to the NMF source model. Again, if using an NN model, step (6) may instead include storing some state information regarding the previous running of the NN model.

In the case of the NMF source model, the portion of q(n|s,z) corresponding to the oldest time frame in the block may be discarded as that time frame itself is discarded. A new frame of q(n|s,z) is initialized for the new time frame. Such initialization may be carried out in any way that is efficient for a particular implementation. The exact manner of initialization is not important since the result will be refined through iterating step (2) described above. In an embodiment, this stage of the method may further include softening other parameters which can be improved through iteration, such as q(d,s), so as to allow the method to more easily adapt if the character of the data streaming changes midway through the stream. In various embodiments, such softening may be done in a variety of ways, such as e.g. adding a constant to all values and renormalizing.

It should be noted that the probabilistic interpretation used in batch mode breaks down slightly in streaming mode because, by assumption, the streaming mode method does not have the information available to normalize over all time. To handle this, one embodiment of the streaming NTF may leave some parameters un-normalized, with their sums indicating the total mass of input data which has contributed to that quantity. For example, it is possible to not normalize X(f,n) over time, but maintain the invariant that q^{old} (d,s) and q^{old}(f,z,s) each always sum to the sum of X(f,n) over all frequencies and time frames before the current block. That way the current block and past before the current block are weighted appropriately relative to each other in equations for the streaming NTF provided above.

Some implementations multiply the q^{old} values by a discount factor between 0 and 1, such as 0.9, each time they are calculated. While this may break the invariant mentioned above, it also has the effect of forgetting some of the past and being more adaptable to changing circumstances.

The streaming NTF method described herein allows many variations in implementation depending on the setting, which would not materially affect performance or which trade one desirable characteristic off in favor of another. Some of these have been mentioned above. Other variations include e.g. using a block size that is variable. In particular, depending on how data becomes available, some embodiments of the streaming NTF method may be configured to add multiple frames to the present block at one time and iterate on these as a group. This could be particularly useful in e.g. a cloud setting where the data may be coming from one machine to another in packets which may arrive out of order. If some data has arrived early, the streaming NTF method may be configured to process it early in order to save time later. Another variation includes using a variable number of iterations per block. This may be beneficial e.g. for varying separation quality based on system load.

One special case could be when a stream terminates: then a mask is computed for all frames through the end of the stream, rather than for only those frames selected in the hyperparameter selection stage. In various embodiments, these could all be computed simultaneously, or zero inputs could be streamed through the system to get it to finish up automatically without treating the end of the stream as a special case.

The streaming method presented above is flexible to easily incorporate all such variations and others.

### Cloud-Based Source Separation Services

An aspect of the present disclosure relates to apparatus, systems, and methods for providing a cloud-based blind source separation service. A computing device can partition the source separation process into a plurality of processing steps, and may identify one or more of the processing steps for execution locally by the device and one or more of the processing steps for execution remotely by one or more servers. This allows the computing device to determine how best to partition the source separation processing based both on the local resources available, the present condition of the network connection between the local and remote resources, and/or other factors relevant to the processing. Such a source separation process may include processing steps of any of the BSS methods described herein, e.g. NMF, basic NTF, NN NTF, basic NTF with NN redux, NN NTF with NN redux, streaming NTF, or any combination thereof. The source separation process may further include one or more processing steps that are uniquely suited to cloud computing, such as pattern matching to a large adaptive data set.

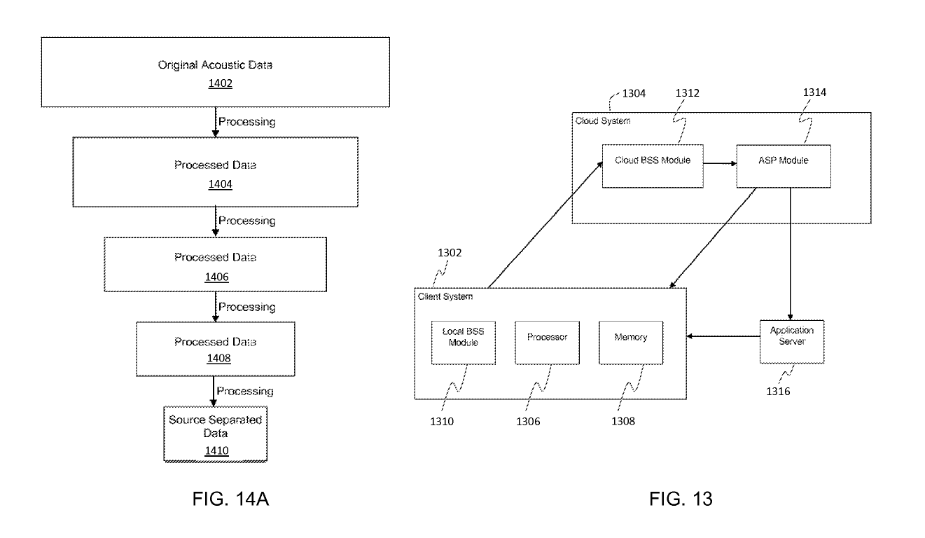

FIG. 13 illustrates a cloud-based blind source separation system in accordance with some embodiments. FIG. 13 includes a client 1302 and a cloud system 1304 in communication with the client 1302. The client device 810 described above may be implemented as such a client 1302, while the server 850 described above may be implemented as such a cloud system 1304. Therefore, all of the discussions of the client 1302 and the cloud system 1304 are applicable to the client device 810 and the server 850 and vice versa.

The client 1302 includes a processor 1306, a memory device 1308, and a local blind source separation (BSS) module 1310. The cloud system 1304 includes a cloud BSS module 1312 and an acoustic signal processing (ASP) module 1314. The client 1302 and the cloud system 1304 communicate via a communication network (not shown).

The client 1302 can receive an acoustic signal that includes a plurality of audio streams, each of which originated from a distinct acoustic source. For example, a first one of the audio streams is a voice signal from a first person and a second one of the audio streams is a voice signal from a second person. As another example, a first one of the audio streams is a voice signal from a first person and a second one of the audio streams is ambient noise. It may be desirable to separate out the acoustic signal into distinct audio streams based on the acoustic sources from which the audio streams originated.

The cloud based BSS mechanism, which includes the local BSS module 1310 and the cloud BSS module 1312, can allow the client 1302 and the cloud system 1304 to distribute the processing required to separate out an acoustic signal into separated audio streams. In some embodiments, the client 1302 is configured to perform BSS locally to separate out an acoustic signal into source separated audio streams at the local BSS module 1310, and the client 1302 can provide the source separated audio streams to the cloud system 1304. In some embodiments, the client 1302 is configured to send an unprocessed acoustic signal to the cloud system 1304 so that the cloud system 1304 can use the cloud BSS module 1312 to separate out the unprocessed acoustic signal into source separated audio streams.

In some embodiments, the client 1302 is configured to pre-process the acoustic signal locally at the local BSS module 1310, and to provide the pre-processed acoustic signal to the cloud system 1304. The cloud system 1304 can subsequently perform BSS based on the pre-processed acoustic signal to provide source separated audio streams. This can allow the client 1302 and the cloud system 1304 to distribute memory usage, computation power, power consumption, energy consumption, and/or other processing resources between the client 1302 and the cloud system 1304.

For example, the local BSS module 1310 can be configured to pre-process the acoustic signal to reduce the noise in the acoustic signal, and provide the de-noised acoustic signal to the cloud system 1304 for further processing. As another example, the local BSS module 1310 can be configured to compress the acoustic signal and provide the compressed acoustic signal to the cloud system 1304 for further processing. As another example, the local BSS module 1310 can be configured to derive features associated with the acoustic signal and provide the features to the cloud system 1304 for blind source separation. The features can include, for example, the direction of arrival information, which can include the bearing and confidence information. The features can also include neural-net based features for generative models, e.g. features of NN models described above. The features can also include local estimates of grouping cues, for instance, harmonic stacks, which includes harmonically related voice bands in the time/frequency spectrum. The features can also include pitch information and formant information.

The source-separated signal may then be sent to an ASP module 1314 which may for example process the signal as speech in order to determine one or more user commands. The ASP module 1314 may be part of the same cloud system 1304 as the cloud BSS module, as shown in FIG. 13. The ASP module 1314 may use any of the data described herein as being used in cloud-based BSS processing in order to increase the quality of the signal processing. In some embodiments, the ASP module 1314 is located remotely from cloud system 1304 (e.g., in a different cloud than cloud system 1304).

Compared to a raw, unprocessed signal, the source-separated signal may greatly increase the quality of the ASP. For example, where the ASP is speech recognition, an unprocessed signal may have an unacceptably high word error rate representing a significant proportion of words that are not correctly identified by the speech recognition algorithms. This may be due to ambient noise, additional voices, and other sounds interfering with the speech recognition. In favorable contrast, a source-separated signal may provide much clearer acoustic data of a user's voice issuing a command, and may therefore result in a significantly improved word error rate. Other acoustic sound processing may similarly benefit from BSS pre-processing.

The ASP can be configured to send processed signals back to the client system 1302 for execution of the command. The processed signals can include, for example, a command. Alternatively or in addition, the processed signal may be sent to application server 1316. The application server 1316 can be associated with a third party, such as an advertising company, a consumer sales company, and/or the like. The application server 1316 can be configured to carry out one or more instructions that would be understood by the third party. For example, where the processed signal represents a command to perform an internet search, the command may be sent to an internet search engine. As another example, where the processed signal a command to carry out commercial activity, the instructions may be sent to a particular online retailer or service-provider to provide the user with advertisements, requested products, and/or the like.

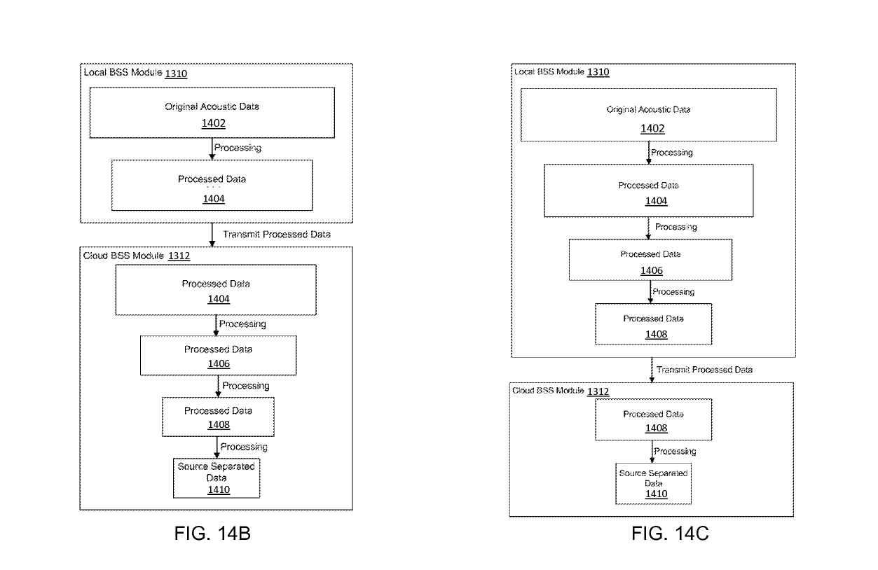

FIGS. 14A-C illustrate how blind source separation processing may be partitioned in different ways between a local client and the cloud, according to some embodiments. FIG. 14A shows a series of processing steps, each of which results in a more refined set of data. The original acoustic data 1402 may undergo a first processing step to result in first intermediate processed data 1404, which is further processed to result in second intermediate processed data 1406, which is further processed to result in third intermediate processed data 1408, which is further processed to generate source separated data 1410. As illustrated, each processing step results in a more refined set of data, which in some implementations may actually represent in a smaller amount of data. The processing that results in each step of data refinement may be any process known in the art, such as noise reduction, compression, signal transformation, pattern matching, etc., many of which are described herein. In some implementations, the system may be configured to determine which processes to use in analyzing a particular recording of acoustic data based on the available resources, the circumstances of the recording, and/or the like.

As shown in FIG. 14B, in one case the system can be configured such that most of the processing is performed to the cloud BSS module 1312 shown in FIG. 13. The local BSS module 1310 (located at, or associated with, the local client system 1302) generates processed data 1404 and the client system 1302 transmits processed data 1404 to the cloud BSS module 1312. The remaining processing shown in FIG. 14A is then performed in the cloud (e.g., resulting in processed data 1406, processed data 1408, and source separated data 1410).

As another example, as shown in FIG. 14C, the system can be configured such that most of the processing is performed by the local BSS module 1310, such that the local BSS module 1310 generates processed data 1408, and the client 1302 transmits processed data 1408 to the cloud for further processing. The cloud BSS module 1312 processes the processed data 1408 to generate source separated data 1410.

In some implementations, the system may use any one of a number of factors to decide how much processing to allocate to the client (e.g., to local BSS module 1310) and how much to allocate to the cloud (e.g., cloud BSS module 1312), which can configure the amount of processing of the data transmitted to the cloud (e.g., at what point in the blind source separation processing the cloud receives data from the client). The factors may include, for example: the current state of the local client, including the available processor resources and charge; the nature of the network connection, including available bandwidth, signal strength, and stability of the connection; the conditions of the recording, including factors that may result in the use of cloud-specific processing steps as further described below; user preferences, including both explicitly stated preferences and preferences determined by the user's history and profile; preferences provided by a third party, such as an internet service provider or device vender; and/or any other relevant parameters.

The ASP module 1314 can include an automatic speech recognition (ASR) module. In some embodiments, the cloud BSS module 1312 and the ASP module 1314 can reside in the same cloud system 1304. In other embodiments, the cloud BSS module 1312 and the ASP module 1314 can reside in different cloud systems.

The cloud BSS module 1312 can use a plurality of servers in parallel to separate out an acoustic signal into source separated streams. For example, the cloud BSS module 1312 can use any appropriate distributed framework as known in the art. To give one particular example, the system could use a MapReduce mechanism for separating out an acoustic signal into source separated streams in parallel.

In the particular example of using MapReduce, in the Map phase, when the cloud BSS module 1312 receives an acoustic signal (or features derived at the local BSS module 1310), the cloud BSS module 1312 can map one or more frames of the acoustic signal to a plurality of servers. For example, the cloud BSS module 1312 can generate frames of the acoustic signal using a sliding temporal window, and map each of the frames of the acoustic signal to one of the plurality of servers in the cloud system 1304.

The cloud BSS module 1312 can use the plurality of servers to perform template matching in parallel. The cloud BSS module 1312 can divide a database of templates into a plurality of sub-databases, and assign one of the plurality of sub-databases to one of the plurality of servers. Then, the cloud BSS module 1312 can configure each of the plurality of servers to determine whether a frame of the acoustic signal assigned to itself matches any one of the templates in its sub-database. For instance, the server can determine, for each template in the sub-database, how likely it is that the frame of the acoustic signal matches the template. The likelihood of the match can be represented as a confidence.

Once the plurality of servers completes the confidence computation process, the cloud BSS module 1312 can move to the reduction phase. In the reduction phase, the cloud BSS module 1312 can consolidate the confidences computed by the plurality of servers to identify, for each frame of the acoustic signal, the template with the highest confidence. Subsequently, the cloud BSS module 1312 can use the template to derive source separate audio streams.

In some embodiments, the cloud BSS module 1312 can perform the MapReduce process in a streaming mode. For example, the cloud BSS module 1312 can segment an acoustic signal into frames using a temporally sliding window, and use the frames for template matching. In other embodiments, the cloud BSS module 1312 can perform the MapReduce process in a bulk mode. For example, the cloud BSS module 1312 can use a global signal transformation, such as Fourier Transform or Wavelet Transform, to transform the acoustic signal to a different domain, and use frames of the acoustic signals in that new domain to perform template matching. The bulk mode MapReduce can allow the cloud BSS module 1312 to take into account the global statistics associated with the acoustic signal.

In some embodiments, the cloud BSS module 1312 can use data gathered from many devices to perform big-data based BSS. For example, the cloud BSS module 1312 can be in communication with an acoustic signal database. The acoustic signal database can maintain a plurality of acoustic signals that can provide a priori information on acoustic signals. The cloud BSS module 1312 can use the a priori information from the database to better separate audio streams from an acoustic signal.

The large database made available on the cloud may aid blind source-separation processing in a number of ways. For example, the cloud device may be able to generate a distance metric in a feature space based on an available library. Where the audio data is compared against a number of templates, the resulting confidence intervals may be taken as a probability distribution, which may be used to generate an expected value. This can, in turn, be used to generate a replacement magnitude spectrum, or instead a mask for the existing data, based on the probability distribution and the expected value. Each of these steps may be performed over a sliding window or over the entire acoustic data as appropriate.

In addition to first-order matching of a large quantity of cloud data to the acoustic data, big-data cloud BSS may also allow for further matching based on hierarchical categorization. In some embodiments, the acoustic signal database can organize the acoustic signals based on the characteristics of the acoustic signals. For example, when an acoustic signal is a voice signal from a male person, the acoustic signal can be identified as a male voice signal. The male voice signal can be further categorized into a low-pitch male voice signal, a mid-pitch male voice signal, and a high-pitch male voice signal, and categorize male voice signals accordingly. In essence, the cloud BSS module 1312 can construct a hierarchical model of acoustic signals. Such a categorization of acoustic signals allow the cloud BSS module 1312 to derive a priori information that are tailored to acoustic signals of particular characteristics, and to use such tailored a priori information, for example, in a topic model, to separate audio streams from an acoustic signal. In some cases, the acoustic signal database can maintain highly granular categories, in which case, the cloud BSS module 1312 can maintain highly tailored a priori information, for example, a priori information associated with a particular person.

In some embodiments, the acoustic signal database can also categorize the acoustic signals based on locations at which the acoustic signals were captured. More particularly, the acoustic signal database can maintain metadata for each acoustic signal, indicating a location from which the acoustic signal was captured. For example, when the acoustic signal database receives an acoustic signal from a location corresponding to a subway station, the acoustic signal database can associate the acoustic signal to the location corresponding to the subway station. When a client 1302 at that location sends a BSS request to the cloud system 1304, the cloud BSS module 1312 can use a priori information associated with that location to improve the BSS performance.

In some embodiments, in addition to a priori information, a cloud-based system may also be able to collect current information associated with a location. For example, if a client device is known to be in a location such as a subway station and three other client devices are also present at the same station, the data from those other client devices can be used to determine the ambient noise of the station to aid in source separation of the client's acoustic data.

In some embodiments, the acoustic signal database can also categorize the acoustic signals based on context in which the acoustic signals are captured. More particularly, the acoustic signal database can maintain metadata for each acoustic signal, indicating a context in which the acoustic signal was captured. For example, when the acoustic signal database can receive an acoustic signal from a location corresponding to a subway station, the acoustic signal database can associate the acoustic signal to the subway station. When a client 1302 at a subway station sends a BSS request to the cloud system 1304, the cloud BSS module 1312 can use a priori information associated with a subway station, even if the client 1302 is located at a different subway station, to improve the BSS performance.

In some embodiments, the cloud BSS module 1312 can be configured to automatically determine a context associated with an input acoustic signal. For example, if an acoustic signal is ambiguous, the cloud BSS module 1312 can be configured to determine the probability that the acoustic signal is associated with a set of contexts. The cloud BSS module 1312 can weigh the a priori information associated with the set of contexts based on the probability associated with the set of contexts to improve the BSS performance.

More generally, the cloud BSS module 1312 can be configured to derive a transfer function for a particular application context. The transfer function can model the multiplicative transformation of an acoustic signal, the additive transformation of the acoustic signal, and/or the like. For example, if an acoustic signal is captured in a noisy tunnel, the reverberation resulting from the tunnel can be modeled as a multiplicative transformation of an acoustic signal and the noise can be modeled as an additive transformation of the acoustic signal. In some embodiments, the transfer function can be learned using a crowd source mechanism. For example, a plurality of clients can be configured to provide acoustic signals, along with the location information of the plurality of clients, to the cloud system 1304. The cloud system 1304 can analyze the received acoustic signals to determine the transfer function for locations associated with the plurality of clients.

In some embodiments, the cloud BSS module 1312 can be configured to use the transfer function to improve the BSS performance. For example, the cloud BSS module 1312 can receive a plurality of acoustic signals associated with a tunnel. From the plurality of acoustic signals, the cloud BSS module 1312 can derive a transfer function associated with the tunnel. Then, when the cloud BSS module 1312 receives an acoustic signal captured from the tunnel, the cloud BSS module 1312 can “undo” the transfer function associated with the tunnel (e.g., dividing the multiplicative transformation and subtracting the additive transformation) to improve the fidelity of the acoustic signal. Such a transfer function removal mechanism can provide a location-specific dictionary to the cloud BSS module 1312.

In some embodiments, an acoustic profile can be constructed based on past interactions with the same local client. For example, certain client devices may be repeatedly used by the same individuals in the same locations. Over time, the system can construct a profile based on previously-collected data from a given device in order to more accurately perform source separation on acoustic data from that device. The profile may include known acoustics for a room or other area, known ambient noise such as household appliances and pets, voice profiles for recognized users, and/or the like. The system can automatically construct a transformation function for the room, filter out the known ambient noise, and better separate out the known voice based on its identified characteristics.

Furthermore, in addition to using data specific to an individual, profile-matching can allow for the construction of hierarchical models based on data from individuals other than the user of a particular local client. For example, a system may be able to apply an existing user's acoustic profile to other users with demographic or geographic similarities to the user.

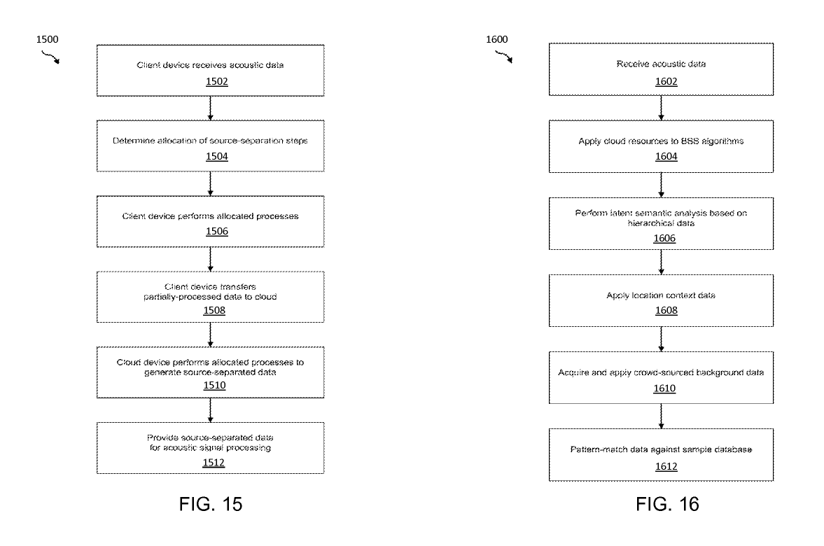

FIG. 15 is a flowchart describing an exemplary method 1500 in accordance with the present disclosure. The steps of the flowchart 1500 may be performed by one or more processors, such as e.g. processors or processing units within client devices 810 and 1302 and/or processors or processing units within servers 850 and 1304 described herein. However, any system configured to perform the methods steps illustrated in FIG. 15 is within the scope of the present disclosure. Furthermore, although the elements are shown in a particular order, it will be understood that particular processing steps may be performed by different computing devices in parallel or in a different order than that shown in the FIGURE.

A client device receives acoustic data (1502). In some embodiments, the client device may be associated with an entertainment center such as a television or computer monitor; in some embodiments, the client device may be a mobile device such as a smart phone or tablet computer. The client device may receive the acoustic data following some cue provided by a user that the user will issue a command, such as pressing a particular button, using a particular gesture, or using a particular key word. Although the sound data processing capabilities described herein may be used in many other contexts, the example explicitly described herein concerns interpreting data that includes a user's speech to determine a command issued by the user.

In response to receiving the acoustic data, the system, which includes both a local device and a cloud device, determines what processing will be performed on the acoustic data in order to carry out source separation. The system then allocates each of the processing steps to either the client device or the cloud (1504). In some implementations, this involves determining a sequence of processing steps and deciding at what point in the sequence to transfer the data from the client to the cloud, as discussed above. The allocation may depend on the resources available locally on the client device, as well as any added value that the cloud may provide in particular aspects of the analysis.

Although this step is described as being carried out prior to the beginning of source-separation processing, in some implementations the evaluation may be ongoing. That is, rather than predetermining at what point in the process the client device will transfer the data, the client device may perform each processing step and then evaluate whether to transfer the data before beginning the next processing step. In this way, the outcome of particular processing may be taken into account when determining to transfer data to the cloud.

The client device carries out partial source-selection processing on the received acoustic data (1506). This may involve any processing step appropriate for the client device; for example, if the client device has additional information relevant to the acoustic data, such as directional data from multiple microphones, the client device may perform processing steps using this additional information. Other steps, such as noise reduction, compression, or feature identification, may also be performed by the client device as allocated.

Once the client device has carried out its part of the source-selection processing, it transfers the partially-processed data to the cloud (1508). The format of the transferred data may differ depending on the stage of processing, and in addition to sending the data, the client device may provide context for the data or even instructions as to how the data should be treated.

The cloud device completes the BSS processing and generates source-separated data (810). As described above, the BSS processing steps performed by the cloud may include more and different capabilities than those available on a client device. For instance, distributed computing may allow large, parallel processing of the data to separate sources faster and with greater fidelity than a single processor. Additional data, in the form of user profiles and/or sample sounds, may also allow the cloud device to perform pattern matching and even hierarchical modeling to increase the accuracy of source separation.

The resulting source-separated acoustic data is provided for acoustic signal processing (812). This step may be performed by a third party. This step may include automated speech recognition in order to determine commands.

FIG. 16 is a flowchart representing an exemplary method 1600 for cloud based source separation in accordance with the present disclosure. The steps of the flowchart 900 may be performed by one or more processors, such as e.g. processors or processing units within client devices 810 and 1302 and/or processors or processing units within servers 850 and 1304 described herein. However, any system configured to perform the methods steps illustrated in FIG. 16 is within the scope of the present disclosure. Furthermore, although the elements are shown in a particular order, it will be understood that particular processing steps may be performed by different computing devices in parallel or in a different order than that shown in the FIGURE.

Each of the steps 1604-1612 represent a process in which data stored in the cloud may be applied to facilitate source-separation processing for received acoustic data (1602). In some implementations, the data that is uploaded to the cloud system may be unprocessed; that is, the client device may not perform any source-separation processing before transferring the data to the cloud. Alternatively, the client may perform some source-separation processing and may transfer the partially-processed data to the cloud.

The cloud system may apply cloud resources to blind source-separation algorithms in order to increase the available processing power and increase the efficiency of those algorithms (1604). For example, cloud resources may allow a direction of arrival calculation, including bearing and confidence intervals, when such calculations would otherwise be too resource-intensive for timely resolution on the client device. Other resource-intensive blind source-separation algorithms that are generally not considered appropriate for real-time calculation may also be applied when the considerable resources of a cloud computing system are available. The use of distributed processing and other cloud-specific data processing techniques may be applied to any appropriate algorithm in order to increase the accuracy and precision of the results in accordance with the resources available.

Based on hierarchical data, which may include user profile information as well as preliminary pattern-matching, the system performs latent semantic analysis on the acoustic data (1606). As described above, the hierarchical data may allow the system to place different components of the acoustic data in accordance with identified categories of various sounds.

The system applies contextual information related to the context of the acoustic data (1608). This may include acoustic or ambient information about the particular area where the client device is, or even the type of area (such as a subway station in the example above). In some implementations, the contextual information may provide sufficient information about the reverb and other acoustic elements to apply a transform to the acoustic data.

The system acquires background data from other users that are in the same or similar locations (1610). These other users essentially provide secondary microphones that can be used to cancel background noise and determine acoustic information about the client device's location.

Unlike the relatively limited storage capacity of most client devices, the cloud may potentially include many thousands of samples of audio data, and may compare this database against received acoustic data in order to identify particular acoustic sources and better separate them (1612).

Any one or combination of these processes, using the cloud's greatly extended resources, may greatly facilitate source-separation and provide a greater degree of accuracy than is possible with a client device's local resources.

Although the claims are presented in single dependency format in the style used before the USPTO, it should be understood that any claim can depend on and be combined with any preceding claim of the same type unless that is clearly technically infeasible.

What is claimed is:

1. A system for processing at least one signal acquired using one or more acoustic sensors, the at least one signal having contributions from one or more acoustic sources, the system comprising:
a memory configured to store computer executable instructions; and
a processor communicatively connected to or comprising the memory and configured, when executing the instructions, to:
obtain sensor data from one or more sensors other than the one or more acoustic sensors; and
use the sensor data in executing an acoustic source separation algorithm on the at least one acquired signal to separate from the at least one acquired signal one or more contributions from a predetermined acoustic source of the one or more acoustic sources.

2. The system according to claim 1, wherein the acoustic source separation algorithm comprises:
computing time-dependent spectral characteristics from the at least one acquired signal, the spectral characteristics comprising a plurality of components;
computing direction estimates from at least two signals acquired using one or more acoustic sensors, each component of a first subset of the plurality of components having a corresponding one or more of the direction estimates; and
performing iterations of a nonnegative tensor factorization (NTF) model for the one or more acoustic sources, the iterations comprising (a) combining values of a plurality of parameters of the NTF model with the computed direction estimates to separate from the acquired signals one or more contributions from the predetermined acoustic source.

3. The system according to claim 1, wherein the acoustic source separation algorithm comprises:
computing time-dependent spectral characteristics from the at least one acquired signal, the spectral characteristics comprising a plurality of components;
applying a first model to the time-dependent spectral characteristics, the first model configured to compute property estimates of a property, each component of a first subset of the components having a corresponding one or more property estimates of the property; and
performing iterations of a nonnegative tensor factorization (NTF) model for the one or more acoustic sources, the iterations comprising (a) combining values of a plurality of parameters of the NTF model with the computed property estimates to separate from the at least one acquired signal one or more contributions from the predetermined acoustic source.

4. The system according to claim 1, wherein the acoustic source separation algorithm comprises:
computing time-dependent spectral characteristics from the at least one acquired signal, the spectral characteristics comprising a plurality of components;
accessing at least a first model configured to predict contributions from the predetermined acoustic source of the one or more acoustic sources; and
performing iterations of a nonnegative tensor factorization (NTF) model for the one or more acoustic sources, the iterations comprising running the first model to separate from the at least one acquired signal one or more contributions from the predetermined acoustic source.

5. The system according to claim 1, wherein the acoustic source separation algorithm comprises:
computing time-dependent spectral characteristics from the at least one acquired signal, the spectral characteristics comprising a plurality of components;
computing direction estimates from at least two signals of one or more signals acquired using the one or more acoustic sensors, each computed component of the spectral characteristics having a corresponding one of the direction estimates;
performing a decomposition procedure using the computed spectral characteristics and the computed direction estimates as input to identify a plurality of sources of the plurality of signals, each component of the spectral characteristics having a computed degree of association with at least one of the identified sources and each source having a computed degree of association with at least one direction estimate; and
using a result of the decomposition procedure to selectively process a signal from one of the sources.

6. The system according to claim 1, wherein the acoustic source separation algorithm comprises:
accessing an indication of a current block size, the current block size defining a size of a portion of the at least one acquired signal to be analyzed to separate from the at least one acquired signal one or more contributions from the predetermined acoustic source of the one or more acoustic sources;
analyzing a first portion of the at least one acquired signal, the first portion being of the current block size, by:
computing one or more first characteristics from data of the first portion, and
using the computed one or more first characteristics, or derivatives thereof, in performing iterations of a nonnegative tensor factorization (NTF) model for the one or more acoustic sources for the data of the first portion to separate, from at least the first portion of the at least one acquired signal, one or more first contributions from the predetermined acoustic source; and
analyzing a second portion of the at least one acquired signal, the second portion being of the current block size and being temporaly shifted with respect to the first portion, by:
computing one or more second characteristics from data of the second portion, and
using the computed one or more second characteristics, or derivatives thereof, in performing iterations of the NTF model for the data of the second portion to separate, from at least the second portion of the at least one acquired signal, one or more second contributions from the predetermined acoustic source.

7. The system according to claim 1, wherein using the sensor data comprises correlating the sensor data to the at least one acquired signal.

8. The system according to claim 1, wherein the sensor data comprises data indicative of occurrence of an event or/and change of a state of a surrounding where the at least one signal is acquired.

9. The system according to claim 8, wherein using the sensor data comprises:
identifying a time instance or a time period of the at least one acquired signal corresponding to a time instance or a time period when the event occurred or the state of the surrounding changed, and
adjusting the acoustic source separation algorithm based on the identified time instance or the time period.

10. The system according to claim 9, wherein adjusting the acoustic source separation algorithm based on the identified time instance or the time period comprises adjusting the acoustic source separation algorithm to account for the occurrence of the event or/and the change of the state of the surrounding.

11. The system according to claim 9, wherein adjusting the acoustic source separation algorithm based on the identified time instance or the time period comprises adjusting noise reduction algorithm to account for the occurrence of the event or/and the change of the state of the surrounding.

12. The system according to claim 1, wherein the processor is further configured to:
determine a location and/or an orientation of the one or more acoustic sensors; and
further use the determined location and/or orientation of the one or more acoustic sensors in executing the acoustic source separation algorithm.

13. The system according to claim 12, wherein the processor is configured to determine the location and/or the orientation of the one or more acoustic sensors based on the sensor data.

14. One or more non-transitory computer readable storage media encoded with software for processing at least one signal acquired using one or more acoustic sensors, the at least one signal having contributions from one or more acoustic sources, the software comprising computer executable instructions configured, when executed, to:
obtain sensor data from one or more sensors other than the one or more acoustic sensors; and
use the sensor data in executing an acoustic source separation algorithm on the at least one acquired signal to separate from the at least one acquired signal one or more contributions from a predetermined acoustic source of the one or more acoustic sources.

15. The one or more non-transitory computer readable storage media according to claim 14, wherein using the sensor data comprises correlating the sensor data to the at least one acquired signal.

16. The one or more non-transitory computer readable storage media according to claim 14, wherein the sensor data comprises data indicative of occurrence of an event or/and change of a state of a surrounding where the at least one signal is acquired.

17. The one or more non-transitory computer readable storage media according to claim 16, wherein using the sensor data comprises:
identifying a time instance or a time period of the at least one acquired signal corresponding to a time instance or a time period when the event occurred or the state of the surrounding changed, and
adjusting the acoustic source separation algorithm based on the identified time instance or the time period.

18. The one or more non-transitory computer readable storage media according to claim 17, wherein adjusting the acoustic source separation algorithm based on the identified time instance or the time period comprises adjusting the acoustic source separation algorithm or/and a noise reduction algorithm to account for the occurrence of the event or/and the change of the state of the surrounding.

19. The one or more non-transitory computer readable storage media according to claim 14, wherein the software further comprises computer executable instructions configured, when executed, to:
determine a location and/or an orientation of the one or more acoustic sensors; and
further use the determined location and/or orientation of the one or more acoustic sensors in executing the acoustic source separation algorithm.

20. A method for processing at least one signal acquired using one or more acoustic sensors, the at least one signal having contributions from one or more acoustic sources, the method comprising:
obtaining sensor data from one or more sensors other than the one or more acoustic sensors; and
using the sensor data in executing an acoustic source separation algorithm on the at least one acquired signal to separate from the at least one acquired signal one or more contributions from a predetermined acoustic source of the one or more acoustic sources.
